(19) United States
(12) Patent Application Publication
(10) Pub. No.: US 2019/0372729 A1
(43) Pub. Date: Dec. 5, 2019

(54) WIRELESS COMMUNICATION APPARATUS, METHODS, PROGRAMS AND RECORDING MEDIA

(71) Applicant: NEC Corporation, Tokyo (JP)

(72) Inventor: Shizen SASAKI, Tokyo (JP)

(73) Assignee: NEC Corporation, Tokyo (JP)

(21) Appl. No.: 16/341,520

(22) PCT Filed: Oct. 2, 2017
(86) PCT No.: PCT/JP2017/035845

§ 371 Date: Apr. 12, 2019

(30) Foreign Application Priority Data
Jan. 11, 2016 (JP) 2016-214075

(51) Int. Cl. H04L 5/00; H04J 13/12

(52) U.S. Cl. CPC H04L 5/0044; H04J 13/12; H04L 5/0007; H04L 5/0073

(57) ABSTRACT

In order to make it possible, in a communication scheme which maps symbols to resource elements arranged in frequency direction and time direction, to mitigate interference that arises in a resource element located at an edge of an allocated radio resource in frequency direction or time direction, a first wireless communication apparatus (300) includes: an orthogonal encoding section (171) configured to generate, using a plurality of orthogonal codes, a second set of symbols from a first set of symbols to be transmitted to a second wireless communication apparatus (400); and a resource mapping section (173) configured to map the second set of symbols to interfering resources which cause an interference affecting a target resource element. The target resource element is located at an edge of a radio resource in frequency direction or time direction, the radio resource being allocated to the first wireless communication apparatus (300) or the second wireless communication apparatus (400), each of the plurality of orthogonal codes includes N elements, the interfering resources are N resource elements, and the N is an odd number.

### BACKGROUND

### Technical Field

The present invention relates to wireless communication apparatuses, methods, programs and recording media.

### Background Art

For example, communication schemes which map symbols to non-orthogonal resource elements arranged in frequency direction and time direction such as Filter Bank Multi-Carrier/Offset Quadrature Amplitude Modulation (FBMC/OQAM) are known.

In such communication schemes, focusing on a single resource element, the single resource element will suffer from an interference from adjacent resource elements regardless of channel fluctuation and presence or absence of noises. For example, in a case where reference signals suffer from such an interference, there is a problem that channel estimation accuracy will deteriorate.

One possible approach to address such a problem is, for example, to map null signals, whose transmission power is zero, to resource elements that are adjacent to the single resource element. While this approach removes a need for additional processing both at transmitting and receiving ends, frequency utilization efficiency will decrease as the number of resource elements that are available for transmission of information decreases.

NPL 1 discloses a method of inserting an auxiliary signal, for the purpose of interference cancellation only, to any of resource elements that exist adjacent to the single resource element. According to the method disclosed in NPL 1, though signal generation process for interference cancellation is required at transmitting end, no additional processing is required at receiving end. However, transmission power needs to be distributed to the auxiliary signal and, thus, transmission power utilization efficiency will decrease.

Besides the above-mentioned two approaches, PTL 1 discloses a method which mitigates an interference that arises at the single resource element by using orthogonal codes, which cancel an interference on the single resource element, to orthogonalize symbols transmitted over the resource elements that are adjacent to the single resource element. The method disclosed in PTL 1 is advantageous in terms of frequency utilization efficiency and transmission power utilization efficiency as all of the resource elements transmitted over the adjacent resource elements are available for transmission of information.

### Patent Literature

[PTL 1] JP 2004-509562 T

### Non-Patent Literature

[NPL 1] J.-P. Javaudin; D. Lacroix; A. Rouxel, “Pilot-aided channel estimation for OFDM/OQAM”, Vehicular Technology Conference, 2003, VTC 2003-Spring, Pages: 1581-1585

### SUMMARY

### Technical Problem

However, since the orthogonal coding scheme disclosed in PTL 1 assumes that interfering resource elements are evenly arranged such that they surround the target resource element of interference mitigation, it was not possible to mitigate interference in a case where the target resource element of interference mitigation is located at an edge of a resource block allocated for a terminal apparatus in frequency direction or time direction, for example.

An example object of the present invention is to make it possible, in a communication scheme which maps symbols to resource elements arranged in frequency direction and time direction, to mitigate interference that arises in a resource element located at an edge of an allocated radio resource in frequency direction or time direction.

### Solution to Problem

A first wireless communication apparatus of the present invention includes: an orthogonal encoding section configured to generate, using a plurality of orthogonal codes, a second set of symbols from a first set of symbols to be transmitted to a second wireless communication apparatus; and a resource mapping section configured to map the second set of symbols to interfering resources which cause an interference affecting a target resource element. The target resource element is located at an edge of a radio resource in frequency direction or time direction, the radio resource being allocated to the first wireless communication apparatus or the second wireless communication apparatus, each of the plurality of orthogonal codes includes N elements, the interfering resources are N resource elements, and the N is an odd number.

A second wireless communication apparatus of the present invention includes: a resource de-mapping section configured to extract, from a signal received from a first wireless communication apparatus, a second set of symbols that are mapped to interfering resources causing an interference affecting a target resource element; and an orthogonal decoding section configured to decode the second set of symbols using a plurality of orthogonal codes to generate a first set of symbols. The target resource element is located at an edge of a radio resource in frequency direction or time direction, the radio resource being allocated to the second wireless communication apparatus or the first wireless communication apparatus, each of the plurality of orthogonal codes includes N elements, the interfering resources are N resource elements, and the N is an odd number.

A first method of the present invention includes: generating, using a plurality of orthogonal codes, a second set of symbols from a first set of symbols to be transmitted from a first wireless communication apparatus to a second wireless communication apparatus; and mapping the second set of symbols to interfering resources which cause an interference affecting a target resource element. The target resource element is located at an edge of a radio resource in frequency direction or time direction, the radio resource being allocated to the first wireless communication apparatus or the second wireless communication apparatus, each of the plurality of orthogonal codes includes N elements, the interfering resources are N resource elements, and the N is an odd number.

A second method of the present invention includes: extracting, from a signal that a second wireless communication apparatus received from a first wireless communication apparatus, a second set of symbols that are mapped to interfering resources causing an interference affecting a target resource element; and decoding the second set of symbols using a plurality of orthogonal codes to generate a first set of symbols. The target resource element is located at an edge of a radio resource in frequency direction or time direction, the radio resource being allocated to the first wireless communication apparatus or the second wireless communication apparatus, each of the plurality of orthogonal codes includes N elements, the interfering resources are N resource elements, and the N is an odd number.

A first program of the present invention is a program for causing a processor to execute: generating, using a plurality of orthogonal codes, a second set of symbols from a first set of symbols to be transmitted from a first wireless communication apparatus to a second wireless communication apparatus; and mapping the second set of symbols to interfering resources which cause an interference affecting a target resource element, and the target resource element is located at an edge of a radio resource in frequency direction or time direction, the radio resource being allocated to the first wireless communication apparatus or the second wireless communication apparatus, each of the plurality of orthogonal codes includes N elements, the interfering resources are N resource elements, and the N is an odd number.

A second program of the present invention is a program for causing a processor to execute: extracting, from a signal that a second wireless communication apparatus received from a first wireless communication apparatus, a second set of symbols that are mapped to interfering resources causing an interference affecting a target resource element; and decoding the second set of symbols using a plurality of orthogonal codes to generate a first set of symbols, and the target resource element is located at an edge of a radio resource in frequency direction or time direction, the radio resource being allocated to the second wireless communication apparatus or the first wireless communication apparatus, each of the plurality of orthogonal codes includes N elements, the interfering resources are N resource elements, and the N is an odd number.

A first recording medium of the present invention is a non-transitory computer-readable recording medium having recorded thereon a program for causing a processor to execute: generating, using a plurality of orthogonal codes, a second set of symbols from a first set of symbols to be transmitted from a first wireless communication apparatus to a second wireless communication apparatus; and mapping the second set of symbols to interfering resources which cause an interference affecting a target resource element, and the target resource element is located at an edge of a radio resource in frequency direction or time direction, the radio resource being allocated to the first wireless communication apparatus or the second wireless communication apparatus, each of the plurality of orthogonal codes includes N elements, the interfering resources are N resource elements, and the N is an odd number.

A second recording medium of the present invention is a non-transitory computer-readable recording medium having recorded thereon a program for causing a processor to execute: extracting, from a signal that a second wireless communication apparatus received from a first wireless communication apparatus, a second set of symbols that are mapped to interfering resources causing an interference affecting a target resource element; and decoding the second set of symbols using a plurality of orthogonal codes to generate a first set of symbols, and the target resource element is located at an edge of a radio resource in frequency direction or time direction, the radio resource being allocated to the second wireless communication apparatus or the first wireless communication apparatus, each of the plurality of orthogonal codes includes N elements, the interfering resources are N resource elements, and the N is an odd number.

### Advantageous Effects of Invention

According to the present invention, it will be possible, in a communication scheme which maps symbols to resource elements arranged in frequency direction and time direction, to mitigate interference that arises in a resource element located at an edge of an allocated radio resource in frequency direction or time direction. Note that the present invention may exert other advantageous effects instead of the above advantageous effect or together with the above advantageous effect.

### BRIEF DESCRIPTION OF THE DRAWINGS

FIG. 1 is a diagram illustrating a configuration of a resource grid of FBMC/OQAM scheme;

FIG. 2 is a diagram schematically illustrating steps of generating a vector y^{(m0,n0)}₈ from a vector x^{(m0,n0)}_{y} using an orthogonal coding matrix C_{8×7} in a case where N=8 and n₀ is an even number;

FIG. 3 is a diagram schematically illustrating steps of mapping real symbols obtained by the steps illustrated in FIG. 2 to interfering resources;

FIG. 4 is a diagram roughly illustrating locations of interfering resources in a case where a target resource element is surrounded by the interfering resources;

FIG. 5 is a diagram illustrating a target resource element (a resource element RS to which a reference signal is mapped) located at an edge of a resource block in time direction;

FIG. 6 is a diagram illustrating a target resource element (a resource element RS to which a reference signal is mapped) located at an edge of a resource block in time direction;

FIG. 7 is a diagram illustrating a target resource element (a resource element RS to which a reference signal is mapped) located at an edge of a resource block in frequency direction;

FIG. 8 is a diagram illustrating a target resource element (a resource element RS to which a reference signal is mapped) located at an edge of a resource block in frequency direction;

FIG. 9 is an explanatory diagram illustrating an example of a schematic configuration of a system 1 according to example embodiments of the present invention;

FIG. 10 is a block diagram illustrating an example of a schematic configuration of a terminal apparatus 100 according to a first example embodiment;

FIG. 11 is a block diagram illustrating an example of a schematic configuration of a base station 200 according to the first example embodiment;

FIG. 12 is a flowchart for describing an example of a schematic flow of a process in the terminal apparatus 100 according to the first example embodiment;

FIG. 13 is a flowchart for describing an example of a schematic flow of a process in the base station 200 according to the first example embodiment;

FIG. 14 is a block diagram illustrating an example of a schematic configuration of a first wireless communication apparatus 300 according to a second example embodiment; and

FIG. 15 is a block diagram illustrating an example of a schematic configuration of a second wireless communication apparatus 400 according to the second example embodiment.

### DESCRIPTION OF THE EXAMPLE EMBODIMENTS

Example embodiments of the present invention will be described in detail below with reference to the accompanying drawings. Note that, in the present specification and drawings, elements to which similar descriptions are applicable are denoted by the same reference signs, whereby overlapping descriptions may be omitted.

Descriptions will be given in the following order.

1. Related Art

2. Overview of Example Embodiments of the Present Invention
2.1. Technical Issues
2.2. Technical Features
2.3. Derivation of Orthogonal Codes used in Example Embodiments

3. Configuration of System

4. First Example Embodiment
4.1. Configuration of Terminal Apparatus
4.2. Configuration of Base Station
4.3. Technical Features
4.4. Example Alterations

5. Second Example Embodiment
5.1. Configuration of First Wireless Communication Apparatus
5.2. Configuration of Second Wireless Communication Apparatus
5.3. Technical Features

### 1. Related Art

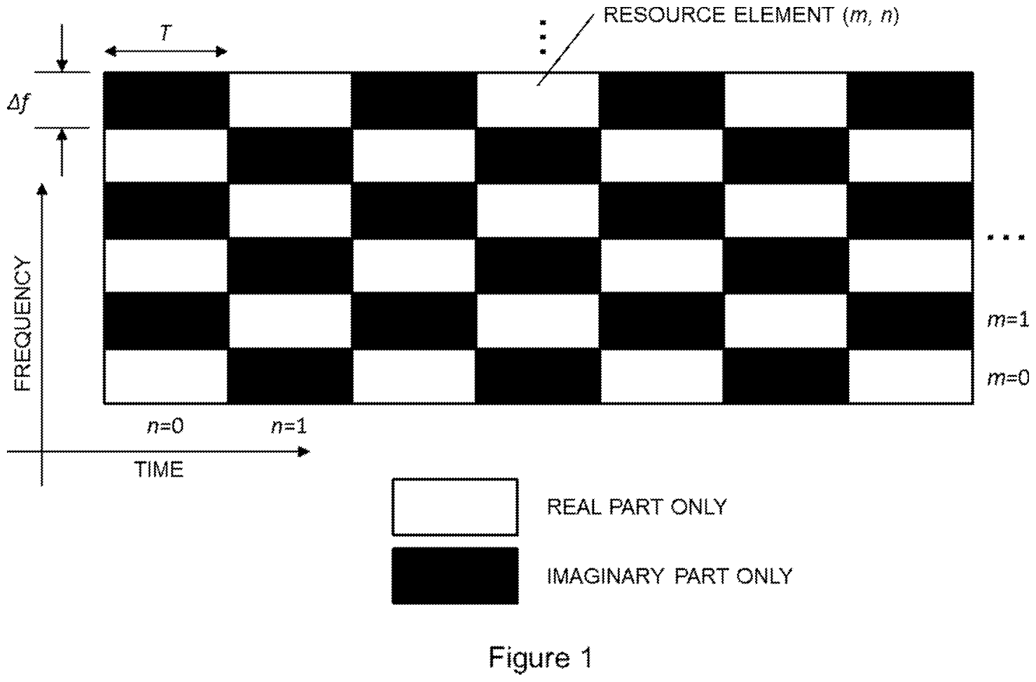

With reference to FIG. 1, the Filter Bank Multi-Carrier/Offset Quadrature Amplitude Modulation (FBMC/OQAM) scheme will be described as a technology related to example embodiments of the present invention.

The FBMC/OQAM scheme is a communication scheme which maps symbols to non-orthogonal resource elements arranged in frequency direction and time direction and is under consideration, as an alternative for OFDM scheme, in development of 5G or New RAT or New Radio (NR), which is a next-generation wireless communication standard, for the following reasons.

In 5G or New RAT or New Radio (NR), which is the next-generation wireless communication standard, it is under consideration to share consecutive frequency bands to efficiently accommodate various wireless communication services with different requirements such as communication speed, communication quality and communication delay. In order to satisfy such different communication requirements, there has been a proposal to use time-frequency resource units that are different per sub-band used by each wireless communication service. As an example, a short-duration time-frequency resource unit is used for a wireless communication service that requires small communication delay.

When different time-frequency resource unit is used for each sub-band, orthogonality between sub-bands is not guaranteed and, thus, an interference between sub-bands may occur. Thus, it has become an issue in terms of frequency utilization efficiency how each sub-band can be densely arranged while reducing the interference.

The conventional Orthogonal Frequency Division Multiplexing (OFDM) adopted in several wireless communication standards such as Long-Term Evolution (LTE), LTE-Advanced and Worldwide Interoperability for Microwave Access (Wimax) causes an interference to outside of the frequency band since a frequency response takes a form of a Sinc function. Hence, an additional filtering process or an insertion of a guard band would be needed to reduce the interference between sub-bands.

In contrast to the above-described OFDM scheme, the FBMC/OQAM scheme uses a filter whose frequency response and impulse response is localized. The localized frequency response allows for reducing the interference to outside of the frequency band compared to the OFDM scheme. The FBMC/OQAM scheme also has an advantage that, as its impulse response is localized, it can alleviate an effect of Inter-Symbol Interference (ISI) without inserting Cyclic Prefix (CP) that causes overhead.

FIG. 1 is a diagram illustrating a configuration of a resource grid of the FBMC/OQAM scheme. In the FBMC/OQAM scheme, as illustrated in FIG. 1, signals which consist of only real parts and signals which consist of only imaginary parts are arranged alternately in time and frequency directions, and they are filtered such that interferences between the real parts and between the imaginary parts become zero.

Note that the FBMC/OQAM scheme is sometimes denoted by a different name such as Orthogonal Frequency Division Multiplexing/Offset Quadrature Amplitude Modulation (OFDM/OQAM) or the like, however, the present specification uses the name of FBMC/OQAM for consistency.

### 2. Overview of Example Embodiments of the Present Invention

First, an overview of example embodiments of the present invention will be described.

### <2.1. Technical Issues>

In the FBMC/OQAM scheme, channel estimation accuracy will deteriorate because a reference signal suffers from an interference caused by resource elements that exist adjacent to a resource element to which the reference signal is mapped. This interference is an intrinsic one and exists at the moment of generating transmission signals regardless of channel fluctuation, presence or absence of noises and the like. This interference is referred to as an imaginary interference as it only contains imaginary parts.

In the FBMC/OQAM scheme, for signals other than the reference signal, the imaginary interference is ignorable since the signals will be finally demodulated in real domain. However, the reference signal is used for estimating fluctuation in amplitude and phase caused by channel on the complex plane and requires processing in complex domain and, thus, the imaginary interference is not ignorable. As a result, channel estimation accuracy deteriorates.

### <2.2. Technical Features>

In the example embodiments, for example, a first wireless communication apparatus (transmitting end) generates, using a plurality of orthogonal codes, a second set of symbols from a first set of symbols to be transmitted to a second wireless communication apparatus (receiving end); and maps the second set of symbols to interfering resources which cause an interference affecting a target resource element. Herein, the target resource element is located at an edge of a radio resource in frequency direction or time direction, the radio resource being allocated to the first wireless communication apparatus or the second wireless communication apparatus. Each of the plurality of orthogonal codes includes N elements. The interfering resources are N resource elements. The N is an odd number.

The first wireless communication apparatus maps the orthogonally encoded second set of symbols to the interfering resources as described above, thereby making it possible to mitigate the interference affecting the target resource element located at the edge in frequency direction or time direction.

Note that the above described technical features are only a specific example of the example embodiments and it is apparent that the example embodiments are not limited to the above described technical features.

<2.3. Derivation of Orthogonal Codes used in Example Embodiments>

With reference to FIGS. 1 to 8, an example of a specific process of deriving orthogonal codes used in the example embodiments will be described. Note that the process of deriving orthogonal codes used in the example embodiments is applicable to the case where there exist interfering resources surrounding a target resource element in addition to the case where a target resource element is located at an edge of a radio resource in frequency direction or time direction. Hence, the case where there exist interfering resources surrounding a target resource element will also be described as a reference example.

Before describing the specific process of deriving orthogonal codes, the FBMC/OQAM scheme and an imaginary interference caused by the scheme will be specifically described using mathematical expressions.

### (As for FBMC/OQAM Scheme)

The FBMC/OQAM scheme is now described. According to the FBMC/OQAM scheme, a real symbol y_{m,n} is mapped to a resource element (m, n) that is defined by the subcarrier index m in frequency domain and the symbol index n in time domain.

For comparison, according to the OFDM scheme, processing such as modulation and pre-coding are performed on transmission bits thereby converting them into complex symbols and the symbols are, then, mapped to resource elements. Meanwhile, according to the FBMC/OQAM scheme, only real symbols can be mapped and, thus, in general, upon generating the complex symbols, they are converted into real symbols. As an example of such conversion from complex symbols to real symbols, it may be considered to divide a real part and an imaginary part of a complex symbol into two real values and to map them to resource elements alternately in frequency direction or time direction.

A transmission signal s(t) of the FBMC/OQAM scheme is expressed as the following expression:

$$s ( t ) = {\sum }_{n = - ∞}^{∞} {\sum }_{m = 0}^{{N}_{sc} - 1} {x}_{m , n} {g}_{m , n} ( t ) \\ {g}_{m , n} ( t ) = {j}^{m + n} {e}^{j 2 π m Δ f t} g ( t - nT ) \qquad ( Expression 1 )$$

In (Expression 1), the real symbol y_{m,n} is multiplied with the prototype filter g(t) for each resource element (m, n) and frequency shift and time shift depending on corresponding resource element indices are applied. Further, phase shift by π/2 units with the term j^{m+n} is performed. In this way, the real parts and imaginary parts are arranged alternately on the resource grid, which represents resource element arrangement in two-dimensional time and frequency form, as in FIG. 1 mentioned above.

There is the following relationship between FBMC/OQAM symbol duration T and subcarrier spacing Δf:

$$T = \frac{1}{2 Δ f} \qquad ( Expression 2 )$$

The prototype filter g(t) is selected from even functions which satisfy the following orthogonality condition:

$${A}_{g} ( 2 pT , 2 q Δ f ) = \{ \begin{matrix}1 , & if ( p , q ) = ( 0 , 0 ) \\ 0 , & otherwise\end{matrix} \qquad ( Expression 3 )$$

Herein, A_{g} is an ambiguity function of the prototype filter g(t) and defined as follows:

$${A}_{g} ( τ , f ) = {\int }_{- ∞}^{∞} g ( t + \frac{τ}{2} ) {g}^{*} ( t - \frac{τ}{2} ) {e}^{- j 2 π ft} dt \qquad ( Expression 4 )$$

From the condition that g(t) is an even function, the ambiguity function A_{g} is always a real function. For example, Isotropic Orthogonal Transform Algorithm (IOTA), Hermite Pulses, Extended Gaussian Function (EGF) or the like is used for the prototype filter g(t) which satisfies the orthogonality condition as represented in (Expression 3). These filters have the characteristic that the impulse response and frequency response are equal with each other and are called isotropic filters.

### (As for Imaginary Interference)

The imaginary interference that occurs in the FBMC/OQAM scheme is now described. For ease of explanation, consider a case where a second wireless communication apparatus (receiving end) directly receives and demodulates the transmission signal s(t) transmitted from a first wireless communication apparatus (transmitting end) with no channel fluctuation and no noise addition. That is, a received signal r(t) is equal to s(t).

In the FBMC/OQAM scheme, the demodulation process for a resource element (m₀, n₀) is performed as follows:

$${x}_{{m}_{0} , {n}_{0}}^{′} = {\int }_{- ∞}^{∞} r ( t ) {g}_{{m}_{0} , {n}_{0}}^{*} ( t ) dt = {x}_{{m}_{0} , {n}_{0}} + {I}_{{m}_{0} , {n}_{0}} \\ \begin{matrix}{I}_{{m}_{0} , {n}_{0}} = {\sum }_{( m , n ) \neq ( {m}_{0} , {n}_{0} )} {x}_{m , n} {\int }_{- ∞}^{∞} {g}_{m , n} ( t ) {g}_{{m}_{0} , {n}_{0}}^{*} ( t ) dt \\ = {\sum }_{( m , n ) \neq ( {m}_{0} , {n}_{0} )} {x}_{m , n} {j}^{( m - {m}_{0} ) + ( n - {n}_{0} ) + ( m - {m}_{0} ) ( n + {n}_{0} )} {A}_{g} ( ( {n}_{0} - n ) T , ( {m}_{0} - m ) Δ f )\end{matrix} \qquad ( Expression 5 )$$

Herein, I_{m0, n0} represents an interference component from adjacent resource elements. Considering that the ambiguity function A_{g} is always a real function and that there is the orthogonality condition of (Expression 3), the interference component I_{m0, n0} consists only of imaginary parts, which results in an imaginary interference.

Herein, when demodulating a real symbol x_{m0, n0} mapped to a resource element (m0, n0), only real parts are finally extracted and, thus, the imaginary interference can be fully removed. Meanwhile, when the x_{m0, n0} is a reference signal, as it is used to estimate fluctuation in amplitude and phase caused by channel on the complex plane, both of values of the real parts and imaginary parts needs to be considered and, thus, the imaginary interference cannot be removed.

This means that, for reference signals, there is intrinsic imaginary interference caused from adjacent resource elements at the moment of generating transmission signals. If channel estimation is performed at receiving end using a reference signal in which the imaginary interference exists, channel estimation accuracy will deteriorate due to the interference component, which causes an increase in bit error rate.

### (As for Orthogonal Coding for Reducing Imaginary Interference)

In order to reduce the imaginary interference, it is considered to map real symbols y, to interfering resources that are adjacent to the target resource element (m0, n0), which is subject to interference mitigation, such that the imaginary interference that arises in the target resource element is zero.

First, a condition to make the imaginary interference that arises in the target resource element (m0, n0) zero is formulated as follows:

$${\sum }_{( m , n ) ∈ {Ω}_{N}^{( {m}_{0} , {n}_{0} )}} {y}_{m , n} {j}^{( m - {m}_{0} ) + ( n - {n}_{0} ) + ( m - {m}_{0} ) ( n + {n}_{0} )} {A}_{g} ( ( {n}_{0} - n ) T , ( {m}_{0} - m ) Δ f ) = 0 \qquad ( Expression 6 )$$

Herein, (m0, n0) is used as indices of the target resource element that is subject to interference mitigation. Ω^{(m0, n0)}_{N} represents a set of indices given to resource elements to which N information symbols after orthogonal encoding are mapped, that is, N resource elements located around the target resource elements.

The real symbols y_{m,n} after orthogonal encoding are generated by an N by N−1 orthogonal coding matrix C as follows:

y_{N}^{(m}^{₀}^{,n}^{₀}⁾=C_{N×N-1}x_{N-1}^{(m}^{₀}^{,n}^{₀}⁾

Herein, the vector y^{(m0, n0)}_{N} is a column vector with the number of elements N and the elements consist of real symbols y_{m,n} after orthogonal encoding, which are mapped to N resource elements located around the target resource element.

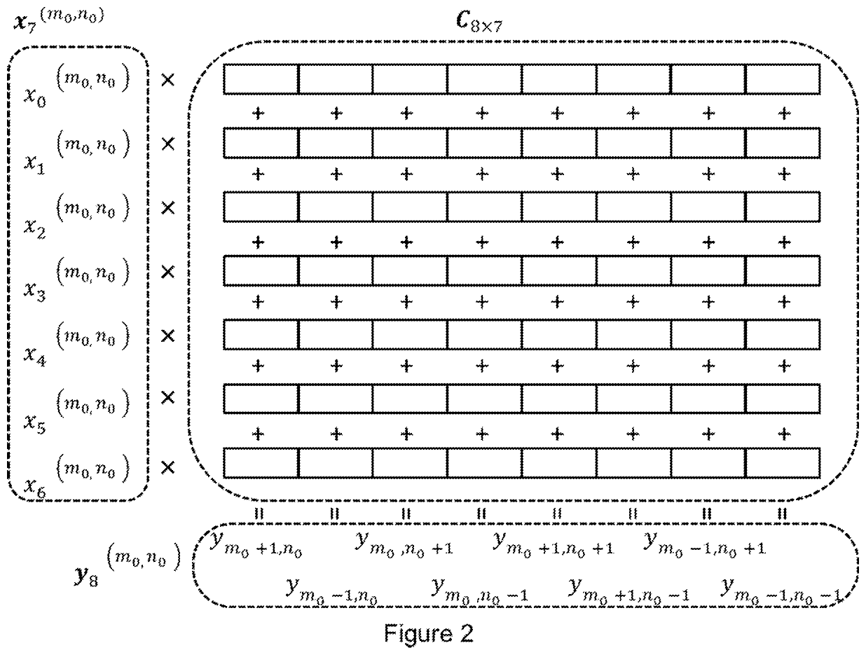

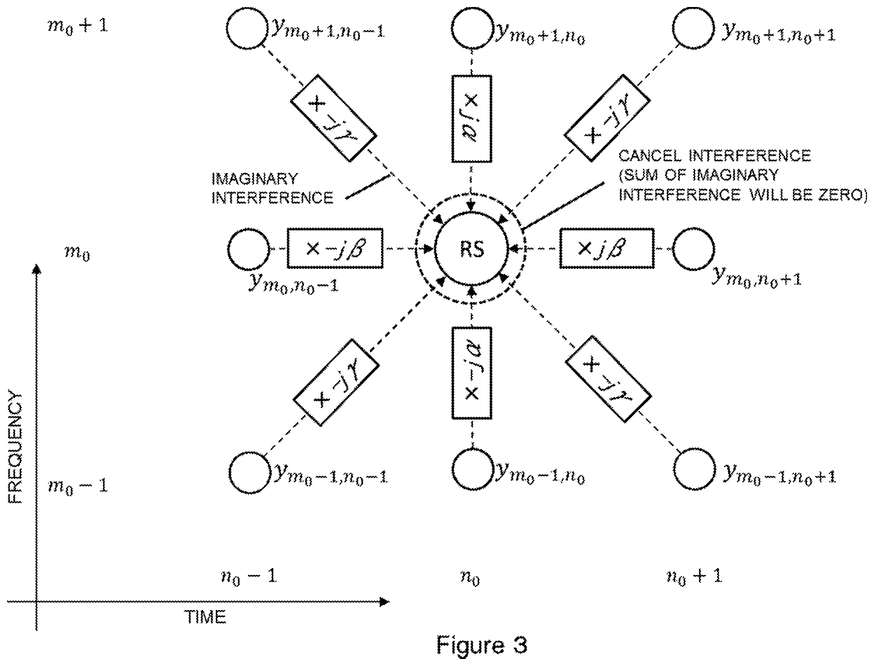

As a reference example, a description on a method of canceling an imaginary interference that arises in a target resource element by mapping orthogonally-encoded real symbols to interfering resources will be given, provided that N=8 and n₀ is an even number. FIG. 2 is a diagram schematically illustrating steps of generating a vector y^{(m0, n0)}₈ from a vector x^{(m0, n0)}₇ using an orthogonal coding matrix C_{8×7} in a case where N=8 and n₀ is an even number. FIG. 3 is a diagram schematically illustrating steps of mapping real symbols obtained by the steps illustrated in FIG. 2 to interfering resources.

First, as shown in FIG. 2, the vector y^{(m0, n0)}_{N} consists of, as its elements, eight orthogonally-encoded real symbols which are mapped to eight resource elements adjacent to the target resource element where N=8. The vector x^{(m0,n0)}_{N-1} is a column vector whose number of elements equals N−1 and the elements consist of real symbols before orthogonal encoding, which is expressed as the following expression:

x_{N-1}^{(m}^{₀}^{,n}^{₀}⁾=[x₀^{(m}^{₀}^{,n}^{₀}⁾x₁^{(m}^{₀}^{,n}^{₀}⁾ . . . x_{N-1}^{(m}^{₀}^{,n}^{₀}⁾]^{T} (Expression 8)

Herein, the real symbols before orthogonal encoding represent the information symbol itself to be transmitted. It should be noted here that the number of information symbols that can be transmitted will be one symbol less than the number of resource elements that can be mapped.

Through the processing as expressed in (Expression 7), each of the (N−1) real symbols before orthogonal encoding is spread by orthogonal codes of sequence length N, that is, orthogonal codes whose number of elements is N, and multiplexing all of them results in N real symbols y_{m,n}. In the reference example shown in FIG. 2, seven information symbols are orthogonalized by the 8 by 7 orthogonal coding matrix C_{8×7} to generate eight real symbols. And then, the generated eight real symbols are mapped to the eight resource elements that are adjacent to the target resource element (the resource element RS to which a reference signal is mapped) as shown in FIG. 3.

Herein, the orthogonal coding matrix C is required to satisfy the following equation:

C_{N×N-1}^{T}C_{N×N-1}=I_{N-1} (Expression 9)

The condition expressed in (Expression 9) enables the receiving end to recover the real symbols before orthogonal encoding using the orthogonal coding matrix C as follows.

Hereinafter, this operation is referred to an orthogonal decoding:

C_{N×N-1}^{T}y_{N}^{(m}^{₀}^{,n}^{₀}⁾=C_{N×N-1}^{T}C_{N×N-1}x_{N-1}^{(m}^{₀}^{,n}^{₀}⁾=x_{N-1}^{(m}^{₀}^{,n}^{₀}⁾ (Expression 10)

Note that, in theory, imaginary interferences may occur from all resource elements whose distance either in time index or frequency index is odd, but attenuate as the distance between resource elements gets larger. For that reason, in the reference example, as shown in FIGS. 2 and 3, the number N of adjacent resource elements that can cause an interference affecting the target resource element is assumed to be eight. In the example embodiments, there will be an assumption that the target resource element is located at an edge, in frequency direction or time direction, of a radio resource, more specifically, a resource block allocated to a terminal apparatus and the N is assumed to be 3 or 5.

The vector y^{(m0,n0)}_{N} varies depending on the number of resource elements of interfering resources N and the location of the target resource element in time-frequency plane (the index (m₀, n₀)).

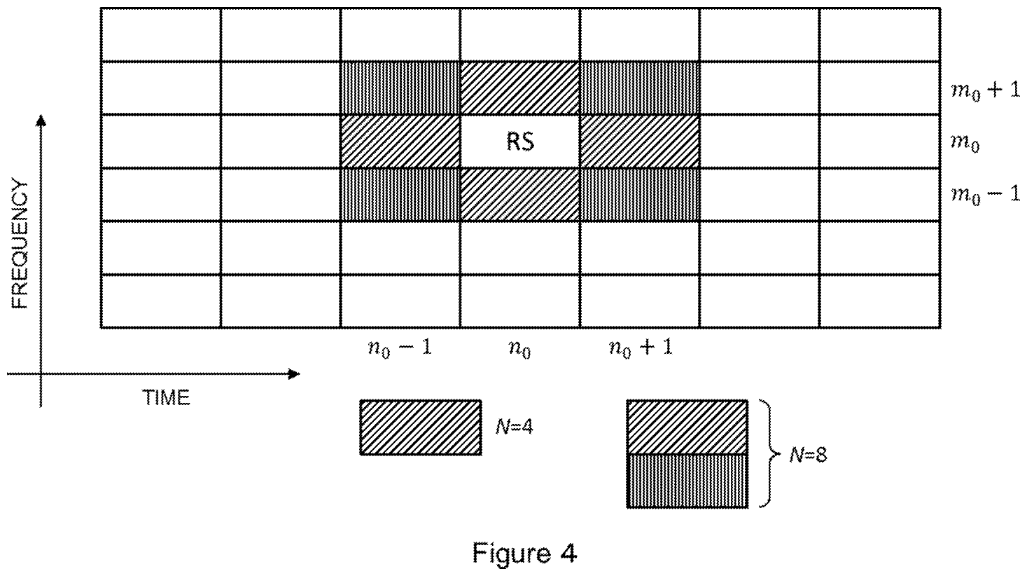

FIG. 4 is a diagram roughly illustrating a target resource element (the resource element RS to which a reference signal is mapped) surrounded by interfering resources as a reference example. The number N of resource elements of interfering resources is 4 or 8 as shown in diagonally-shaded portion in FIG. 4. Real symbols mapped to the interfering resources are expressed as follows:

y₄^{(m}^{₀}^{,n}^{₀}⁾=[yₘ_{₀}_{-1,n}_{₀}yₘ_{₀}_{-1,n}_{₀}yₘ_{₀}ₙ_{₀}₊₁yₘ_{₀}ₙ_{₀}₋₁]^{T}

y₈^{(m}^{₀}^{,n}^{₀}⁾=[yₘ_{₀}_{-1,n}_{₀}yₘ_{₀}_{-1,n}_{₀}yₘ_{₀}ₙ_{₀}₊₁yₘ_{₀}ₙ_{₀}₋₁yₘ_{₀}_{-1,n}_{₀}₊₁yₘ_{₀}_{-1,n}_{₀}₋₁yₘ_{₀}_{-1,n}_{₀}₊₁yₘ_{₀}_{-1,n}_{₀}₊₁]^{T} (Expression 11)

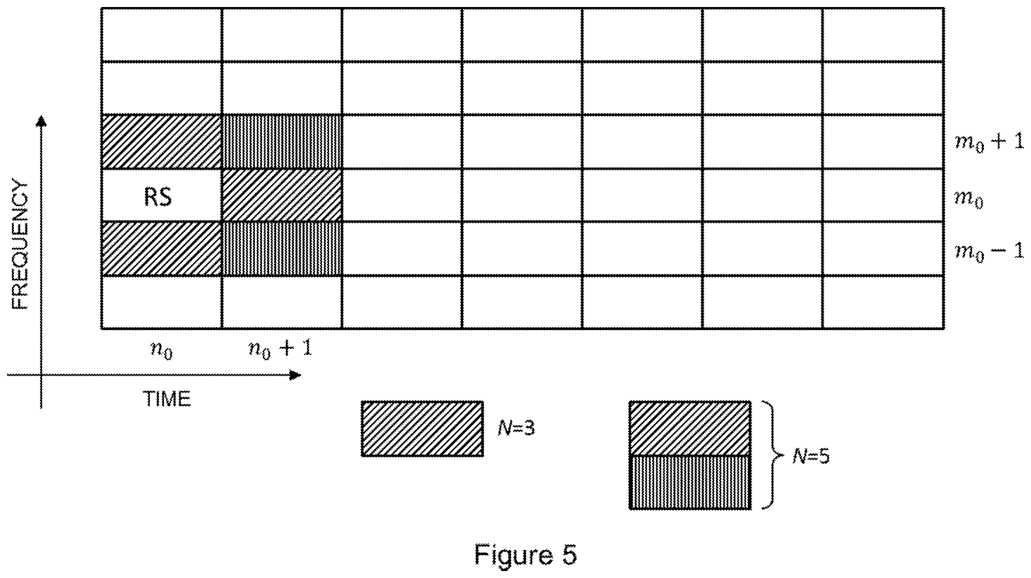

FIG. 5 is a diagram illustrating a target resource element (the resource element RS to which a reference signal is mapped) located at an edge of a resource block in time direction. The number N of resource elements of interfering resources is 3 or 5 as shown in diagonally-shaded portion in FIG. 5. Real symbols mapped to the interfering resources are expressed as follows:

y₃^{(m}^{₀}^{,n}^{₀}⁾=[yₘ_{₀}_{+1,n}_{₀}yₘ_{₀}_{-1,n}_{₀}yₘ_{₀}ₙ_{₀}₊₁]^{T}

y₅^{(m}^{₀}^{,n}^{₀}⁾=[yₘ_{₀}_{+1,n}_{₀}yₘ_{₀}_{-1,n}_{₀}yₘ_{₀}_{-1,n}_{₀}₊₁yₘ_{₀}_{+1,n}_{₀}₊₁yₘ_{₀}ₙ_{₀}₊₁]^{T} (Expression 12)

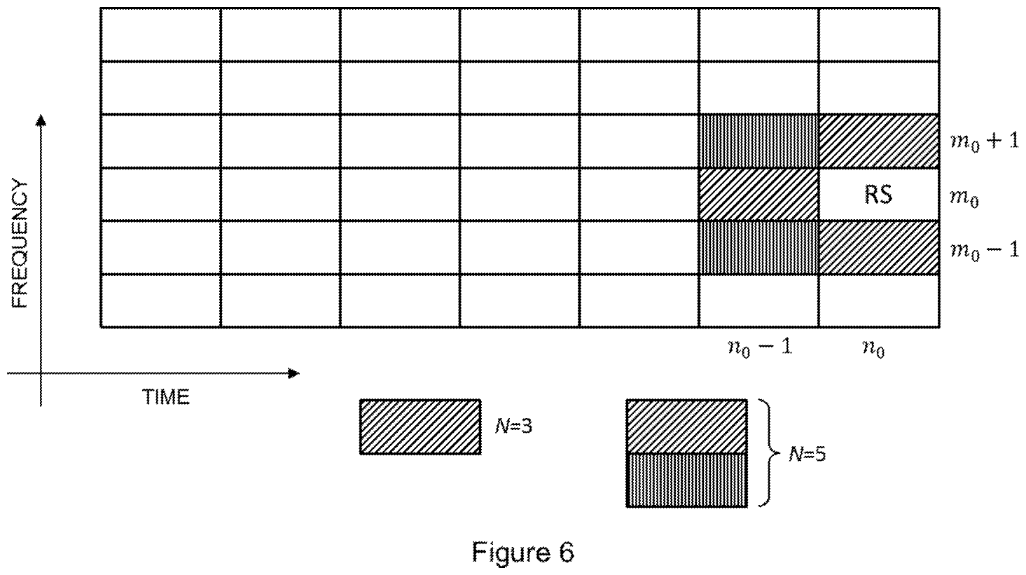

FIG. 6 is a diagram illustrating a target resource element (the resource element RS to which a reference signal is mapped) located at an edge of a resource block in time direction. The number N of resource elements of interfering resources is 3 or 5 as shown in diagonally-shaded portion in FIG. 6. Real symbols mapped to the interfering resources are expressed as follows:

y₃^{(m}^{₀}^{,n}^{₀}⁾=[yₘ_{₀}_{+1,n}_{₀}yₘ_{₀}_{-1,n}_{₀}yₘ_{₀}ₙ_{₀}₋₁]^{T}

y₅^{(m}^{₀}^{,n}^{₀}⁾=[yₘ_{₀}_{+1,n}_{₀}yₘ_{₀}_{-1,n}_{₀}yₘ_{₀}_{-1,n}_{₀}₋₁yₘ_{₀}_{+1,n}_{₀}₋₁yₘ_{₀}ₙ_{₀}₋₁]^{T} (Expression 13)

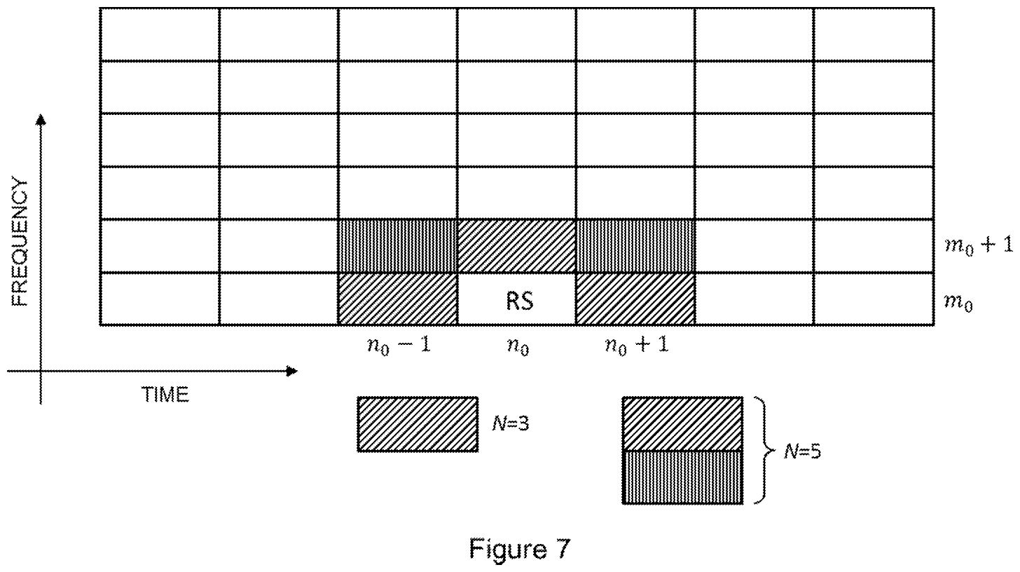

FIG. 7 is a diagram illustrating a target resource element (the resource element RS to which a reference signal is mapped) located at an edge of a resource block in frequency direction. The number N of resource elements of interfering resources is 3 or 5 as shown in diagonally-shaded portion in FIG. 7. Real symbols mapped to the interfering resources are expressed as follows:

y₃^{(m}^{₀}^{,n}^{₀}⁾=[yₘ_{₀}ₙ_{₀}₊₁yₘ_{₀}_{,n}_{₀}₋₁yₘ_{₀}_{+1,n}_{₀}]^{T}

y₅^{(m}^{₀}^{,n}^{₀}⁾=[yₘ_{₀}ₙ_{₀}₊₁yₘ_{₀}_{,n}_{₀}₋₁yₘ_{₀}_{-1,n}_{₀}₋₁yₘ_{₀}_{+1,n}_{₀}₊₁yₘ_{₀}_{+1,n}_{₀}]^{T} (Expression 14)

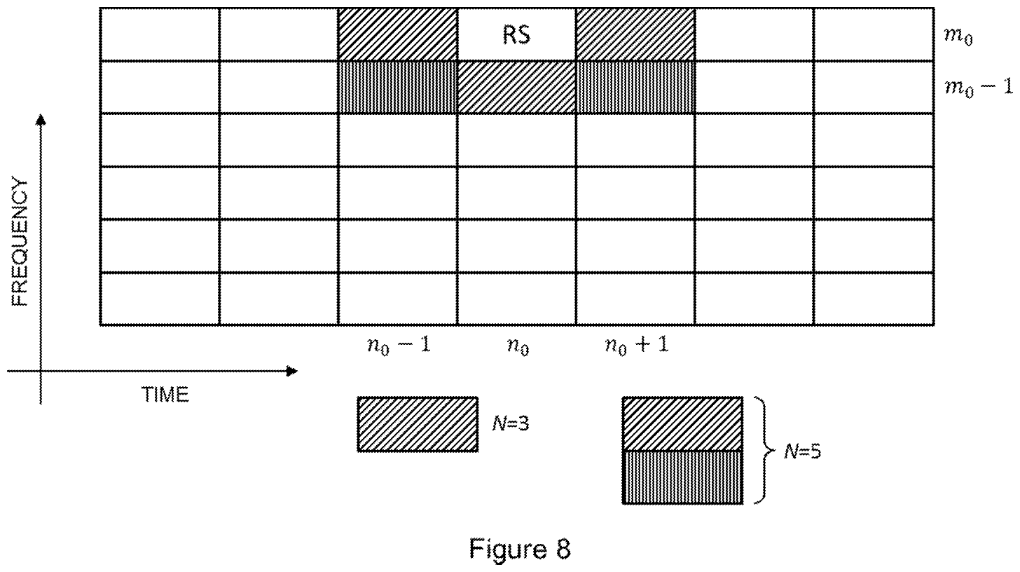

FIG. 8 is a diagram illustrating a target resource element (the resource element RS to which a reference signal is mapped) located at an edge of a resource block in frequency direction. The number N of resource elements of interfering resources is 3 or 5 as shown in diagonally-shaded portion in FIG. 8. Real symbols mapped to the interfering resources are expressed as follows:

y₃^{(m}^{₀}^{,n}^{₀}⁾=[yₘ_{₀}ₙ_{₀}₊₁yₘ_{₀}_{,n}_{₀}₋₁yₘ_{₀}_{+1,n}_{₀}]^{T}

y₅^{(m}^{₀}^{,n}^{₀}⁾=[yₘ_{₀}ₙ_{₀}₊₁yₘ_{₀}_{,n}_{₀}₋₁yₘ_{₀}_{-1,n}_{₀}₋₁yₘ_{₀}_{-1,n}_{₀}₊₁yₘ_{₀}_{-1,n}_{₀}]^{T} (Expression 15)

### (As for how to Generate Orthogonal Coding Matrix C)

In the example embodiments, a description will be given by enlarging the scope of the prototype filter g(t) to include prototype filters whose impulse responses are real functions and even functions in addition to isotropic filters generally used in the FBMC/OQAM scheme. Under this assumption, the following relationship with regard to the ambiguity function A_{g} in (Expression 6) is satisfied:

A_{g}(0,Δf)=A_{g}(0,−Δf)=α

A_{g}(T,0)=A_{g}(−T,0)=β

A_{g}(T,Δf)=A_{g}(−T,Δf)=A_{g}(−T,−Δf)=A_{g}(T,−Δf)=γ (Expression 16)

Herein, when the prototype filter g(t) is an isotropic filter, α=β is true. Hereinafter, α, β and γ are referred to as interference coefficients. α is an interference coefficient for a resource element with one frequency index offset, β is an interference coefficient for a resource element with one time index offset and γ for a resource element both with one frequency index offset and one time index offset.

Now, conditional expressions for making an imaginary interference zero depending on location of a target resource element will be given. Note that, for later descriptions, elements of each matrix and vector in case of expressing the conditional expressions in the following form using matrices and vectors will be described together.

a_{N}S_{N}y_{N}^{(m}^{₀}^{,n}^{₀}⁾=0 (Expression 17)

Herein, a_{N} is a column vector whose number of elements is N and the elements consist of any of the interference coefficients α, β and γ, and is hereinafter referred to as interference coefficient vector. The interference coefficient vector is configured such that a set of identical interference coefficients are populated first and remaining interference coefficients succeed them. Herein, when N=3 or 4, γ is set to be zero since interferences from resource elements with one offset both in frequency index and time index is not considered. S_{N} is an N-th order diagonal matrix and its diagonal components take values of either 1 or −1.

In the case shown in FIG. 4, that is, when N=4 or 8, the conditional expression for making an imaginary interference zero is as follows:

α(yₘ_{₀}_{+1,n}_{₀}−yₘ_{₀}_{-1,n}_{₀})+(−1)ⁿ^{₀}β(yₘ_{₀}ₙ_{₀}₊₁−yₘ_{₀}ₙ_{₀}₋₁)−γ(yₘ_{₀}_{-1,n}_{₀}₋₁+yₘ_{₀}_{+1,n}_{₀}₋₁+yₘ_{₀}_{-1,n}_{₀}₊₁+yₘ_{₀}_{+1,n}_{₀}₊₁)=0 (Expression 18)

When expressing (Expression 18) in the form of (Expression 17), each matrix and vector will be as follows:

a₄=[ααββ]

a₈=[ααββγγγγ]

S₄=diag(1−1(−1)ⁿ^{₀}(−1)ⁿ^{₀}⁺¹)

S₈=diag(1−1(−1)ⁿ^{₀}(−1)ⁿ^{₀}⁺¹−1−1−1−1) (Expression 19)

In the case shown in FIG. 5, that is, when N=3 or 5, the conditional expression for making an imaginary interference zero is as follows:

α(yₘ_{₀}_{+1,n}_{₀}−yₘ_{₀}_{-1,n}_{₀})+(−1)ⁿ^{₀}βyₘ_{₀}_{,n}_{₀}₊₁−γ(yₘ_{₀}_{-1,n}_{₀}₊₁+yₘ_{₀}_{-1,n}_{₀}₊₁)=0 (Expression 20)

When expressing (Expression 20) in the form of (Expression 17), each matrix and vector will be as follows:

a₃=[ααβ]

a₅=[ααγγβ]

S₃=diag(1−1(−1)ⁿ^{₀})

S₅=diag(1−1−1−1(−1)ⁿ^{₀}) (Expression 21)

In the case shown in FIG. 6, that is, when N=3 or 5, the conditional expression for making an imaginary interference zero is as follows:

α(yₘ_{₀}_{+1,n}_{₀}−yₘ_{₀}_{-1,n}_{₀})−(−1)ⁿ^{₀}βyₘ_{₀}_{,n}_{₀}₋₁−γ(yₘ_{₀}_{-1,n}_{₀}₋₁+yₘ_{₀}_{+1,n}_{₀}₋₁)=0 (Expression 22)

When expressing (Expression 22) in the form of (Expression 17), each matrix and vector will be as follows:

a₃=[ααβ]

a₅=[ααγγβ]

S₃=diag(1−1(−1)ⁿ^{_{O}}⁺¹)

S₅=diag(1−1−1−1(−1)ⁿ^{_{O}}⁺¹) (Expression 23)

In the case shown in FIG. 7, that is, when N=3 or 5, the conditional expression for making an imaginary interference zero is as follows:

αyₘ_{₀}_{+1,n}_{₀}+(−1)ⁿ^{₀}β(yₘ_{₀}_{,n}_{₀}₊₁−yₘ_{₀}_{,n}_{₀}₋₁)−γ(yₘ_{₀}_{+1,n}_{₀}₋₁+yₘ_{₀}_{+1,n}_{₀}₊₁)=0 (Expression 24)

When expressing (Expression 24) in the form of (Expression 17), each matrix and vector will be as follows:

a₃=[ββα]

a₅=[ββγγα]

S₃=diag((−1)ⁿ^{₀}(−1)ⁿ^{₀}⁺¹1)

S₅=diag((−1)ⁿ^{₀}(−1)ⁿ^{₀}⁺¹−1−11) (Expression 25)

In the case shown in FIG. 8, that is, when N=3 or 5, the conditional expression for making an imaginary interference zero is as follows:

αyₘ_{₀}_{-1,n}_{₀}+(−1)ⁿ^{₀}β(yₘ_{₀}_{,n}_{₀}₊₁−yₘ_{₀}_{,n}_{₀}₋₁)−γ(yₘ_{₀}_{-1,n}_{₀}₋₁+yₘ_{₀}_{-1,n}_{₀}₊₁)=0 (Expression 26)

When expressing (Expression 26) in the form of (Expression 17), each matrix and vector will be as follows:

a₃=[ββα]

a₅=[ββγγα]

S₃=diag((−1)ⁿ^{₀}(−1)ⁿ^{₀}⁺¹−1)

S₅=diag((−1)ⁿ^{₀}(−1)ⁿ^{₀}⁺¹−1−1−1) (Expression 27)

Herein, an N by N−1 matrix D is introduced and the orthogonal coding matrix C is set as follows:

C_{N×N-1}=S_{N}D_{N×N-1} (Expression 28)

Then, the conditional expression (Expression 17) for making an imaginary interference zero can be transformed using (Expression 7) and (Expression 28) as follows:

a_{N}S_{N}y_{N}^{(m}^{₀}^{,n}^{₀}⁾=a_{N}S_{N}S_{N}D_{N×N-1}x_{N-1}^{(m}^{₀}^{,n}^{₀}⁾=a_{N}D_{N×N-1}x_{N-1}^{(m}^{₀}^{,n}^{₀}⁾=0 (Expression 29)

Herein, in order to let (Expression 29) always true regardless of the value of the vector x^{(m}^{₀}^{,n}^{₀}⁾_{N-1} before orthogonal encoding, the following expression needs to be satisfied:

a_{N}D_{N×N-1}=0 (Expression 30)

Further, the following expression needs to be satisfied with regard to the matrix D from (Expression 9) and (Expression 28):

C_{N×N-1}^{T}C_{N×N-1}=D_{N×N-1}^{T}S_{N}^{T}S_{N}D_{N×N-1}=D_{N×N-1}^{T}D_{N×N-1}=I_{N-1} (Expression 31)

Thus, the matrix D needs to be determined such that (Expression 30) and (Expression 31) are satisfied. This is equivalent to determining its elements such that the following N-th order square matrix G will be an orthogonal matrix:

$${G}_{N} = [ \begin{matrix}\frac{{a}_{N}}{‖ {a}_{N} ‖} \\ {D}_{N \times N - 1}^{T}\end{matrix} ] \qquad ( Expression 32 )$$

Herein, the notation ∥⋅∥ represents Euclidean norm of a vector.

If the matrix G is a square matrix, the following equation will be true because of the definition of orthogonal matrices:

$$\begin{matrix}{G}_{N} {G}_{N}^{T} = [ \begin{matrix}\frac{{a}_{N}}{‖ {a}_{N} ‖} \\ {D}_{N \times N - 1}^{T}\end{matrix} ] [ \begin{matrix}\frac{{a}_{N}^{T}}{‖ {a}_{N} ‖} & {D}_{N \times N - 1}\end{matrix} ] \\ = [ \begin{matrix}\frac{{a}_{N}}{‖ {a}_{N} ‖} \frac{{a}_{N}^{T}}{‖ {a}_{N} ‖} & \frac{{a}_{N}}{‖ {a}_{N} ‖} {D}_{N \times N - 1} \\ {D}_{N \times N - 1}^{T} \frac{{a}_{N}^{T}}{‖ {a}_{N} ‖} & {D}_{N \times N - 1}^{T} {D}_{N \times N - 1}\end{matrix} ] = [ \begin{matrix}1 & 0 \\ 0 & {I}_{N - 1}\end{matrix} ]\end{matrix} \qquad ( Expression 33 )$$

The conditions in (Expression 30) and (Expression 31) can be derived from this (Expression 33). Substituting the matrix D determined such that the matrix G will be a square matrix into (Expression 28) leads to the orthogonal coding matrix C.

### (As for how to Generate Orthogonal Matrix G)

As described above, in order to generate the orthogonal coding matrix C, elements of the orthogonal matrix G defined in (Expression 32) needs to be defined first. Herein, when a square matrix is an orthogonal matrix, it equivalently means that all of row vectors of the square matrix constitute orthonormal bases. Therefore, elements of the orthogonal matrix G can be defined by configuring all of the row vectors as orthonormal bases. Herein, when a set of vectors constitutes orthonormal bases inner product between any pair of the vectors is zero and Euclidean norms of all of the vectors are one.

GramSchmidt orthonormalization can be used as a basic method for generating orthonormal bases. When this orthonormalization is used, there is flexibility on how to select orthonormal bases and, as a result, absolute values of respective elements of orthogonal codes assigned to each information symbol sometimes become uneven. In this case, transmission energy for each information symbol may not spread evenly over resource elements and diversity effect may decrease. Further, if each element of the finally-generated orthogonal coding matrix C cannot be represented in simple form using 1 or −1, multiplication causes increase in amount of calculation.

In the example embodiments, a partial matrix of a Hadamard matrix, whose elements are 1 or −1, and row vectors calculated so as to maximize diversity order are used together in an orthogonal coding matrix C, thereby aiming both at reducing amount of calculation and obtaining diversity effect. In addition, as absolute values of elements from 2n-th column and 2n+1-th column of the orthogonal coding matrix C will be equal with each other, advantageously, transmission energy for each information symbol will be spread more evenly over a plurality of resource elements and further diversity effect can be achieved at the same time. Note that the Hadamard matrix may be applied for deriving the orthogonal coding matrix C only in the part where symmetric property of coefficients is satisfied.

Specifically, elements of the orthogonal matrix G are determined and the orthogonal coding matrix is generated according to the following generation procedure. Hereinafter, p A q represents q-th power of p and floor(k) represents the maximum integer that is equal to or smaller than k.

First, an interference coefficient vector a which is normalized such that the Euclidean norm thereof is 1 is set to the first row of the N-th order square matrix G.

Next, from a Hadamard matrix having order of 2\hat{ }floor(log₂N), every row whose sum of elements from 2n-th column and 2n+1-th column is zero is extracted, and is set to the second or succeeding row of the square matrix G in a left-aligned manner. Herein, when the number of columns of the Hadamard matrix is smaller than N, zeros are inserted to the remaining columns. Further, normalization is performed on the extracted row vector such that its Euclidean norm becomes 1.

Finally, unknown numbers are set to the elements of 2n-th column and 2n+1-th column in remaining every row of the square matrix G and the unknown numbers are determined such that all of the row vectors constitute orthonormal bases. Next, specific procedure for applying the above generation method in the cases of N=3, 4, 5 or 8 will be described.

### (How to Generate Orthogonal Matrix G and Orthogonal Coding Matrix C in Case of N=3)

Consider N=3. First, an interference coefficient vector a normalized such that its Euclidean norm is 1 is set to the first row of third order square matrix G. Next, from a Hadamard matrix having order of 2\hat{ }floor(log₂N), rows whose sums of elements from 2n-th column and 2n+1-th column are zero are extracted. As N=3 means 2\hat{ }floor(log₂N)=2, the following second order Hadamard matrix is used:

$${H}_{2} = [ \begin{matrix}1 & 1 \\ 1 & - 1\end{matrix} ] \qquad ( Expression 34 )$$

The partial matrix obtained by extracting, from this, a row whose sum of elements from 2n-th column and 2n+1-th column is zero will be as follows:

H′₂=[1−1] (Expression 35)

Furthermore, according to the above-described generation method, the following square matrix G is obtained through normalizing and setting the partial matrix and setting unknown numbers:

$${G}_{3} = [ \begin{matrix}\frac{{a}_{3}}{\vert {a}_{3} \vert} \\ {D}_{3 \times 2}^{T}\end{matrix} ] = \frac{1}{\sqrt{2}} [ \begin{matrix}{a}_{0} & {a}_{0} & {a}_{1} \\ 1 & - 1 & 0 \\ {d}_{0} & {d}_{0} & {d}_{1}\end{matrix} ] \qquad ( Expression 36 )$$

Herein, normalized elements of the interference coefficient vector a are, in the cases of FIGS. 5 and 6, as follows:

$$\{ \begin{matrix}{a}_{0} = \sqrt{\frac{2}{2 {α}^{2} + {β}^{2}}} α \\ {a}_{1} = \sqrt{\frac{2}{2 {α}^{2} + {β}^{2}}} β\end{matrix} \qquad ( Expression 37 )$$

In the cases of FIGS. 7 and 8, they are as follows:

$$\{ \begin{matrix}{a}_{0} = \sqrt{\frac{2}{{α}^{2} + 2 {β}^{2}}} β \\ {a}_{1} = \sqrt{\frac{2}{{α}^{2} + 2 {β}^{2}}} α\end{matrix} \qquad ( Expression 38 )$$

Finally, the unknown numbers d₀ and d₁ are solved such that all of row vectors of the square matrix G constitute orthonormal bases. The following simultaneous equations are satisfied because of the conditions of inner product and Euclidean norm of orthonormal basis:

$$\{ \begin{matrix}2 {a}_{0} {d}_{0} + {a}_{1} {d}_{1} = 0 \\ 2 {d}_{0}^{2} + {d}_{1}^{2} = 2\end{matrix} \qquad ( Expression 39 )$$

The following values can be obtained as one of solutions of the above simultaneous equations and the elements that render the square matrix G an orthogonal matrix are determined.

$$\{ \begin{matrix}{d}_{0} = \frac{{a}_{1}}{\sqrt{2}} \\ {d}_{1} = \frac{2 {a}_{0}}{\sqrt{2}}\end{matrix} \qquad ( Expression 40 )$$

By substituting the matrix D derived from the orthogonal matrix G into (Expression 28), the orthogonal coding matrix C for the case of N=3 is obtained:

$${C}_{3 \times 2} = {S}_{3} {D}_{3 \times 2} = \frac{1}{\sqrt{2}} {S}_{3} [ \begin{matrix}1 & {d}_{0} \\ - 1 & {d}_{0} \\ 0 & {d}_{1}\end{matrix} ] \qquad ( Expression 41 )$$

According to (Expression 7), each column of the orthogonal coding matrix C is used as an orthogonal code for orthogonally encoding information symbols x₀^{(m0,n0)}, x₁^{(m0,n0)}. As a specific example, an information symbol x₀^{(m0,n0)} is orthogonally encoded with an orthogonal code (1, −1, 0). Herein, each of the orthogonal codes consists of N (three) elements in which a pair of two elements having the same absolute values is included.

Now, processing operations of orthogonal encoding at transmitting end and orthogonal decoding at receiving end using the orthogonal coding matrix C are described. According to FIG. 4, a target resource element in the case of n₀ being an even number is considered.

First, at transmitting end, each element value of the orthogonal coding matrix C_{3×2} is determined by substituting S₃ as defined by (Expression 21) into (Expression 41). Next, two information symbols x₀^{(m0,n0)}, x₁^{(m0,n0)} are orthogonally encoded according to (Expression 7) thereby three real symbols y₀^{(m0,n0)}, y₁^{(m0,n0)}, y₂^{(m0,n0)} are obtained. These processing operations are expressed by the following expressions:

$${y}_{3}^{( {m}_{0} , {n}_{0} )} = [ \begin{matrix}{y}_{{m}_{0} + 1 , {n}_{0}} \\ {y}_{{m}_{0} - 1 , {n}_{0}} \\ {y}_{{m}_{0} , {n}_{0} + 1}\end{matrix} ] = {C}_{3 \times 2} {x}_{2}^{( {m}_{0} , {n}_{0} )} = \frac{1}{\sqrt{2}} [ \begin{matrix}{x}_{0}^{( {m}_{0} , {n}_{0} )} + {d}_{0} {x}_{1}^{( {m}_{0} , {n}_{0} )} \\ {x}_{0}^{( {m}_{0} , {n}_{0} )} - {d}_{0} {x}_{1}^{( {m}_{0} , {n}_{0} )} \\ {d}_{1} {x}_{1}^{( {m}_{0} , {n}_{0} )}\end{matrix} ] \qquad ( Expression 42 )$$

The three real symbols are mapped respectively to three resource elements (m₀+1, n₀), (m₀−1, n₀) and (m₀, n₀+1), which are adjacent to the target resource element. Specifically, the values respectively derived from the symbols x₀^{(m0,n0)}, x₁^{(m0,n0)} using two elements with the same absolute values are mapped to the two resource elements (m₀+1, n₀), (m₀−1, n₀) that cause the same absolute level of interference to the target resource element and three real symbols y₀^{(m0,n0)}, y₁^{(m0,n0)}, y₂^{(m0,n0)} are transmitted.

At receiving end, after removing channel fluctuation and noise components from received symbols mapped to the three resource elements, orthogonal decoding according to (Expression 10) is performed. Assuming that the channel fluctuation and noise components can be ideally removed, as expressed in the following expression, the information symbols x₀^{(m0,n0)}, x₁^{(m0,n0)} can be decoded using the orthogonal coding matrix C_{3×2} that is the same one as used at transmitting end.

C_{3×2}^{T}y₃^{(m}^{₀}^{,n}^{₀}⁾=C₃₌₂^{T}C₃₌₂x₂^{(m}^{₀}^{,n}^{₀}⁾=x₂^{(m}^{₀}^{,n}^{₀}⁾ (Expression 43)

These processing operations are applied to the cases of N=4, 5 or 8 in a similar manner.

### (How to Generate Orthogonal Matrix G and Orthogonal Coding Matrix C in Case of N=4)

Consider N=4 as a reference example. First, an interference coefficient vector a normalized such that its Euclidean norm is 1 is set to the first row of fourth order square matrix G. Next, from a Hadamard matrix having order of 2\hat{ }floor(log₂N), rows whose sums of elements from 2n-th column and 2n+1-th column are zero are extracted. As N=4 means 2\hat{ }floor(log₂N)=4, the following fourth order Hadamard matrix is used:

$${H}_{4} = [ \begin{matrix}1 & 1 & 1 & 1 \\ 1 & - 1 & 1 & - 1 \\ 1 & - 1 & - 1 & 1 \\ 1 & 1 & - 1 & - 1\end{matrix} ] \qquad ( Expression 44 )$$

The partial matrix obtained by extracting, from this, rows whose sums of elements from 2n-th column and 2n+1-th column are zero will be as follows:

$${H}_{4}^{′} = [ \begin{matrix}1 & - 1 & 1 & - 1 \\ 1 & - 1 & - 1 & 1\end{matrix} ] \qquad ( Expression 45 )$$

Furthermore, according to the above-described generation method, the following square matrix G is obtained through normalizing and setting the partial matrix and setting unknown numbers:

$${G}_{4} = [ \begin{matrix}\frac{{a}_{4}}{\vert {a}_{4} \vert} \\ {D}_{4 \times 3}^{T}\end{matrix} ] = \frac{1}{2} [ \begin{matrix}{a}_{0} & {a}_{0} & {a}_{1} & {a}_{1} \\ 1 & - 1 & 1 & - 1 \\ 1 & - 1 & - 1 & 1 \\ {d}_{0} & {d}_{0} & {d}_{1} & {d}_{1}\end{matrix} ] \qquad ( Expression 46 )$$

Herein, normalized elements of the interference coefficient vector a are as follows:

$$\{ \begin{matrix}{a}_{0} = \sqrt{\frac{2}{{α}^{2} + {β}^{2}}} α \\ {a}_{1} = \sqrt{\frac{2}{{α}^{2} + {β}^{2}}} β\end{matrix} \qquad ( Expression 47 )$$

Finally, the unknown numbers d₀ and d₁ are solved such that all of row vectors of the square matrix G constitute orthonormal bases. The following simultaneous equations are satisfied because of the conditions of inner product and Euclidean norm of orthonormal basis:

$$\{ \begin{matrix}{a}_{0} {d}_{0} + {a}_{1} {d}_{1} = 0 \\ {d}_{0}^{2} + {d}_{1}^{2} = 2\end{matrix} \qquad ( Expression 48 )$$

The following values can be obtained as one of solutions of the above simultaneous equations and the elements that render the square matrix G an orthogonal matrix are determined.

$$\{ \begin{matrix}{d}_{0} = {a}_{1} \\ {d}_{1} = - {a}_{0}\end{matrix} \qquad ( Expression 49 )$$

By substituting the matrix D derived from the orthogonal matrix G into (Expression 28), the orthogonal coding matrix C for the case of N=4 is obtained:

$${C}_{4 \times 3} = {S}_{4} {D}_{4 \times 3} = \frac{1}{2} {S}_{4} [ \begin{matrix}1 & 1 & {d}_{0} \\ - 1 & - 1 & {d}_{0} \\ 1 & - 1 & {d}_{1} \\ - 1 & 1 & {d}_{1}\end{matrix} ] \qquad ( Expression 50 )$$

According to (Expression 7), each column of the orthogonal coding matrix C is used as an orthogonal code for orthogonally encoding information symbols x₀^{(m0,n0)}, x₁^{(m0,n0)}, x₂^{(m0,n0)}, Each of the orthogonal codes consists of N (four) elements in which two pairs of respective two elements having the same absolute values are included as the diagonal elements of the diagonal matrix S are 1 or −1.

### (How to Generate Orthogonal Matrix G and Orthogonal Coding Matrix C in Case of N=5)

Consider N=5. First, an interference coefficient vector a normalized such that its Euclidean norm is 1 is set to the first row of fifth order square matrix G. Next, from a Hadamard matrix having order of 2\hat{ }floor(log₂N), rows whose sums of elements from 2n-th column and 2n+1-th column are zero are extracted. As N=5 means 2\hat{ }floor(log₂N)=4, the fourth order Hadamard matrix in (Expression 44) and the partial matrix in (Expression 45) are used.

Furthermore, according to the above-described generation method, the following square matrix G is obtained through normalizing and setting the partial matrix and setting unknown numbers:

$${G}_{5} = [ \begin{matrix}\frac{{a}_{5}}{\vert {a}_{5} \vert} \\ {D}_{5 \times 4}^{T}\end{matrix} ] = \frac{1}{2} [ \begin{matrix}{a}_{0} & {a}_{0} & {a}_{1} & {a}_{1} & {a}_{2} \\ 1 & - 1 & 1 & - 1 & 0 \\ 1 & - 1 & - 1 & 1 & 0 \\ {d}_{0} & {d}_{0} & {d}_{1} & {d}_{1} & {d}_{2} \\ {d}_{3} & {d}_{3} & {d}_{4} & {d}_{4} & {d}_{5}\end{matrix} ] \qquad ( Expression 51 )$$

Herein, normalized elements of the interference coefficient vector a are, in the cases of FIGS. 5 and 6, as follows:

$$\{ \begin{matrix}{a}_{0} = \frac{2 α}{\sqrt{2 {α}^{2} + {β}^{2} + 2 {γ}^{2}}} \\ {a}_{1} = \frac{2 γ}{\sqrt{2 {α}^{2} + {β}^{2} + 2 {γ}^{2}}} \\ {a}_{2} = \frac{2 β}{\sqrt{2 {α}^{2} + {β}^{2} + 2 {γ}^{2}}}\end{matrix} \qquad ( Expression 52 )$$

In the cases of FIGS. 7 and 8, they are as follows:

$$\{ \begin{matrix}{a}_{0} = \frac{2 β}{\sqrt{{α}^{2} + 2 {β}^{2} + 2 {γ}^{2}}} \\ {a}_{1} = \frac{2 γ}{\sqrt{{α}^{2} + 2 {β}^{2} + 2 {γ}^{2}}} \\ {a}_{2} = \frac{2 α}{\sqrt{{α}^{2} + 2 {β}^{2} + 2 {γ}^{2}}}\end{matrix} \qquad ( Expression 53 )$$

Finally, the unknown numbers d₀ to d₅ are solved such that all of row vectors of the square matrix G constitute orthonormal bases. The following simultaneous equations are satisfied because of the conditions of inner product and Euclidean norm of orthonormal basis:

$$\{ \begin{matrix}2 {a}_{0} {d}_{0} + 2 {a}_{1} {d}_{1} + {a}_{2} {d}_{2} = 0 \\ 2 {a}_{0} {d}_{3} + 2 {a}_{1} {d}_{4} + {a}_{2} {d}_{5} = 0 \\ 2 {d}_{0} {d}_{3} + {d}_{1} {d}_{4} + {d}_{2} {d}_{5} = 0 \\ 2 {d}_{0}^{2} + 2 {d}_{1}^{2} + {d}_{2}^{2} = 4 \\ 2 {d}_{3}^{2} + 2 {d}_{4}^{2} + {d}_{5}^{2} = 4\end{matrix} \qquad ( Expression 54 )$$

In this case, solutions are not definitely determined because there are five independent equations including six unknown numbers. Hence, as an example, the following condition is added:

d₃=d₀ (Expression 55)

This yields the following values as a solution of the simultaneous equations and the elements that render the square matrix G an orthogonal matrix are determined.

$$\{ \begin{matrix}{d}_{0} = {d}_{3} = - \frac{\sqrt{P}}{2} \\ {d}_{1} = \frac{1}{\sqrt{P}} ( {a}_{0} {a}_{1} - \frac{2 {a}_{1}^{2}}{{a}_{2}} ) + \frac{\sqrt{P}}{{a}_{2}} \\ {d}_{2} = \frac{1}{\sqrt{P}} ( {a}_{0} {a}_{2} - 2 {a}_{1} ) \\ {d}_{4} = \frac{1}{\sqrt{P}} ( {a}_{0} {a}_{1} - \frac{2 {a}_{1}^{2}}{{a}_{2}} - 2 {a}_{2} ) + \frac{\sqrt{P}}{{a}_{2}} \\ {d}_{5} = \frac{1}{\sqrt{P}} ( {a}_{0} {a}_{2} + 2 {a}_{1} )\end{matrix} \\ P = 2 {a}_{1}^{2} + {a}_{2}^{2} \qquad ( Expression 56 )$$

By substituting the matrix D derived from the orthogonal matrix G into (Expression 28), the orthogonal coding matrix C for the case of N=5 is obtained:

$${C}_{5 \times 4} = {S}_{5} {D}_{5 \times 4} = \frac{1}{2} {S}_{5} [ \begin{matrix}1 & 1 & {d}_{0} & {d}_{3} \\ - 1 & - 1 & {d}_{0} & {d}_{3} \\ 1 & - 1 & {d}_{1} & {d}_{4} \\ - 1 & 1 & {d}_{1} & {d}_{4} \\ 0 & 0 & {d}_{2} & {d}_{5}\end{matrix} ] \qquad ( Expression 57 )$$

According to (Expression 7), each column of the orthogonal coding matrix C is used as an orthogonal code for orthogonally encoding information symbols x₀^{(m0,n0)}, x₁^{(m0,n0)}, x₂^{(m0,n0)}, x₃^{(m0,n0)}. Herein, each of the orthogonal codes consists of N (five) elements in which two pairs of respective two elements having the same absolute values are included as the diagonal elements of the diagonal matrix S are 1 or −1.

### (How to Generate Orthogonal Matrix G and Orthogonal Coding Matrix C in Case of N=8)

Consider N=8 as a reference example. First, an interference coefficient vector a normalized such that its Euclidean norm is 1 is set to the first row of eighth order square matrix G. Next, from a Hadamard matrix having order of 2\hat{ }floor(log₂N), rows whose sums of elements from 2n-th column and 2n+1-th column are zero are extracted. As N=8 means 2\hat{ }floor(log₂N)=8, the following eighth order Hadamard matrix is used.

$${H}_{8} = [ \begin{matrix}1 & 1 & 1 & 1 & 1 & 1 & 1 & 1 \\ 1 & - 1 & 1 & - 1 & 1 & - 1 & 1 & - 1 \\ 1 & - 1 & - 1 & 1 & 1 & - 1 & - 1 & 1 \\ 1 & - 1 & 1 & - 1 & - 1 & 1 & - 1 & 1 \\ 1 & - 1 & - 1 & 1 & - 1 & 1 & 1 & - 1 \\ 1 & 1 & - 1 & - 1 & 1 & 1 & - 1 & - 1 \\ 1 & 1 & - 1 & - 1 & - 1 & - 1 & 1 & 1 \\ 1 & 1 & 1 & 1 & - 1 & - 1 & - 1 & - 1\end{matrix} ] \qquad ( Expression 58 )$$

The partial matrix obtained by extracting, from this, rows whose sums of elements from 2n-th column and 2n+1-th column are zero will be as follows:

$${H}_{8}^{′} = [ \begin{matrix}1 & - 1 & 1 & - 1 & 1 & - 1 & 1 & - 1 \\ 1 & - 1 & - 1 & 1 & 1 & - 1 & - 1 & 1 \\ 1 & - 1 & 1 & - 1 & - 1 & 1 & - 1 & 1 \\ 1 & - 1 & - 1 & 1 & - 1 & 1 & 1 & - 1\end{matrix} ] \qquad ( Expression 59 )$$

Furthermore, according to the above-described generation method, the following square matrix G is obtained through normalizing and setting the partial matrix and setting unknown numbers:

$${G}_{8} = [ \begin{matrix}\frac{{a}_{8}}{\vert {a}_{8} \vert} \\ {D}_{8 \times 7}^{T}\end{matrix} ] = \frac{1}{2 \sqrt{2}} [ \begin{matrix}{a}_{0} & {a}_{0} & {a}_{1} & {a}_{1} & {a}_{2} & {a}_{2} & {a}_{2} & {a}_{2} \\ 1 & - 1 & 1 & - 1 & 1 & - 1 & 1 & - 1 \\ 1 & - 1 & - 1 & 1 & 1 & - 1 & - 1 & 1 \\ 1 & - 1 & 1 & - 1 & - 1 & 1 & - 1 & 1 \\ 1 & - 1 & - 1 & 1 & - 1 & 1 & 1 & - 1 \\ {d}_{0} & {d}_{0} & {d}_{1} & {d}_{1} & {d}_{2} & {d}_{2} & {d}_{3} & {d}_{3} \\ {d}_{4} & {d}_{4} & {d}_{5} & {d}_{5} & {d}_{6} & {d}_{6} & {d}_{7} & {d}_{7} \\ {d}_{8} & {d}_{8} & {d}_{9} & {d}_{9} & {d}_{10} & {d}_{10} & {d}_{11} & {d}_{11}\end{matrix} ] \qquad ( Expression 60 )$$

Herein, normalized elements of the interference coefficient vector a are as follows:

$$\{ \begin{matrix}{a}_{0} = \frac{2 α}{\sqrt{{α}^{2} + {β}^{2} + 2 {γ}^{2}}} \\ {a}_{1} = \frac{2 β}{\sqrt{{α}^{2} + {β}^{2} + 2 {γ}^{2}}} \\ {a}_{2} = \frac{2 γ}{\sqrt{{α}^{2} + {β}^{2} + 2 {γ}^{2}}}\end{matrix} \qquad ( Expression 61 )$$

Finally, the unknown numbers d₀ to d₁₁ are solved such that all of row vectors of the square matrix G constitute orthonormal bases. The following simultaneous equations are satisfied because of the conditions of inner product and Euclidean norm of orthonormal basis.

$$\{ \begin{matrix}{a}_{0} {d}_{0} + {a}_{1} {d}_{1} + {a}_{2} ( {d}_{2} + {d}_{3} ) = 0 \\ {a}_{0} {d}_{4} + {a}_{1} {d}_{5} + {a}_{2} ( {d}_{6} + {d}_{7} ) = 0 \\ {a}_{0} {d}_{8} + {a}_{1} {d}_{9} + {a}_{2} ( {d}_{10} + {d}_{11} ) = 0 \\ {d}_{0} {d}_{4} + {d}_{1} {d}_{5} + {d}_{2} {d}_{6} + {d}_{3} {d}_{7} = 0 \\ {d}_{0} {d}_{8} + {d}_{1} {d}_{9} + {d}_{2} {d}_{10} + {d}_{3} {d}_{11} = 0 \\ {d}_{4} {d}_{8} + {d}_{5} {d}_{9} + {d}_{6} {d}_{10} + {d}_{7} {d}_{11} = 0 \\ {d}_{0}^{2} + {d}_{1}^{2} + {d}_{2}^{2} + {d}_{3}^{2} = 4 \\ {d}_{4}^{2} + {d}_{5}^{2} + {d}_{6}^{2} + {d}_{7}^{2} = 4 \\ {d}_{8}^{2} + {d}_{9}^{2} + {d}_{10}^{2} + {d}_{11}^{2} = 4\end{matrix} \qquad ( Expression 62 )$$

In this case, solutions are not definitely determined because there are nine independent equations including twelve unknown numbers. Hence, as an example, the following conditions are added:

$$\{ \begin{matrix}{d}_{2} = - {d}_{3} \\ {d}_{4} = - {d}_{5} \\ {d}_{8} = {d}_{9}\end{matrix} \qquad ( Expression 63 )$$

This yields the following values as a solution of the simultaneous equations and the elements that render the square matrix G an orthogonal matrix are determined.

$$\{ \begin{matrix}{d}_{0} = - {d}_{6} = - {d}_{11} = {a}_{1} \\ {d}_{1} = - {d}_{7} = {d}_{10} = - {a}_{0} \\ {d}_{2} = - {d}_{3} = {d}_{4} = - {d}_{5} = - {d}_{8} = - {d}_{9} = - {a}_{2}\end{matrix} \qquad ( Expression 64 )$$

By substituting the matrix D derived from the orthogonal matrix G into (Expression 28), the orthogonal coding matrix C for the case of N=8 is obtained:

$${C}_{8 \times 7} = {S}_{8} {D}_{8 \times 7} = \frac{1}{2 \sqrt{2}} {S}_{8} [ \begin{matrix}1 & 1 & 1 & 1 & {d}_{0} & {d}_{4} & {d}_{8} \\ - 1 & - 1 & - 1 & - 1 & {d}_{0} & {d}_{4} & {d}_{8} \\ 1 & - 1 & 1 & - 1 & {d}_{1} & {d}_{5} & {d}_{9} \\ - 1 & 1 & - 1 & 1 & {d}_{1} & {d}_{5} & {d}_{9} \\ 1 & 1 & - 1 & - 1 & {d}_{2} & {d}_{6} & {d}_{10} \\ - 1 & - 1 & 1 & 1 & {d}_{2} & {d}_{6} & {d}_{10} \\ 1 & - 1 & - 1 & 1 & {d}_{3} & {d}_{7} & {d}_{11} \\ - 1 & 1 & 1 & - 1 & {d}_{3} & {d}_{7} & {d}_{11}\end{matrix} ] \qquad ( Expression 65 )$$

According to (Expression 7), each column of the orthogonal coding matrix C is used as an orthogonal code for orthogonally encoding information symbols x₀^{(m0,n0)}, x₁^{(m0,n0)}, x₂^{(m0,n0)}, x₃^{(m0,n0)}, x₄^{(m0,n0)}, x₅^{(m0,n0)}, x₆^{(m0,n0)}. Each of the orthogonal codes consists of N (eight) elements in which four pairs of respective two elements having the same absolute values are included as the diagonal elements of the diagonal matrix S are 1 or −1.

Note that some other conditions may be added to adjust the number of independent equations to align it with the number of unknown numbers. Possible examples may include fixing values of some unknown numbers to an integer such as 1 or the like, or minimizing dispersion of power between branches by, e.g., Lagrange's method of undetermined multipliers or the like. Further, an optimization approach can be applied to the calculation such as, introducing an unknown number into every element of the matrix and selecting elements with less dispersion of absolute values or lowering dispersion of power between resource elements, for example.

### 3. Configuration of System

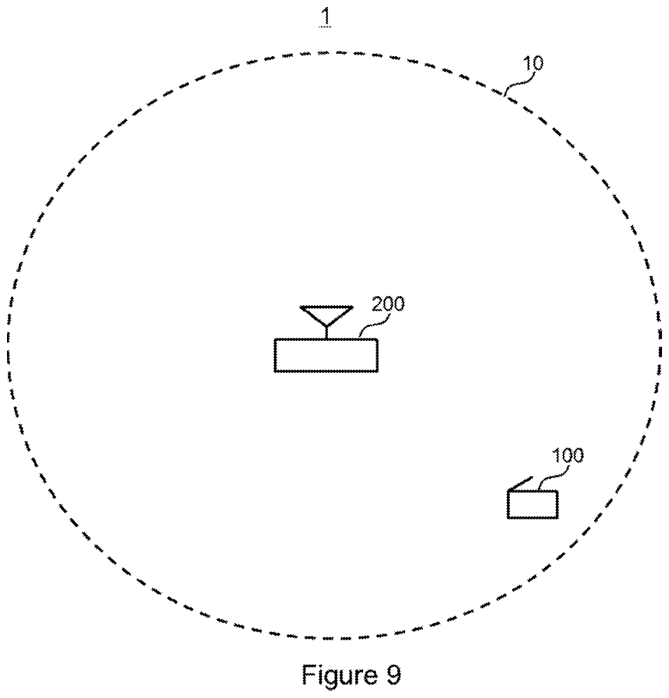

With reference to FIG. 9, an example of the system 1 according to example embodiments of the present invention will be described. FIG. 9 is an explanatory diagram illustrating an example of a schematic configuration of the system 1 according to example embodiments of the present invention. Referring to FIG. 9, the system 1 includes a terminal apparatus 100 and a base station 200.

For example, the system 1 is a system that conforms to a standard of Third Generation Partnership Project (3GPP). More specifically, the system 1 may be a system that conforms to LTE/LTE-Advanced and/or System Architecture Evolution (SAE). Alternatively, the system 1 may be a system that conforms to fifth generation (5G) standard. The system 1 is, of course, not limited to such examples.

(1) Terminal Apparatus 100

The terminal apparatus 100 performs wireless communication with a base station. For example, the terminal apparatus 100 performs wireless communication with the base station 200 when it is located within the coverage area 10 of the base station 200. For example, the terminal apparatus 100 is a user equipment (UE) and receives a signal from a base station in downlink and transmits a signal to the base station in uplink.

(2) Base Station 200

The base station 200 is a node of a radio access network (RAN) and performs wireless communication with terminal apparatuses (for example, terminal apparatus 100) located within the coverage area 10. For example, the base station 200 is an eNB.

The base station 200 is a node which performs wireless communication with terminal apparatuses and, in other words, is a Radio Access Network (RAN) node. For example, the base station 200 may be an evolved Node B (eNB) or a generation Node B (gNB) in 5G. The base station 200 may include a plurality of units (or a plurality of nodes). The plurality of units (or plurality of nodes) may include a first unit (or first node) for performing processing of a higher protocol layer and a second unit (or second node) for performing processing of a lower protocol layer. As an example, the first unit may be referred to as Center/Central Unit (CU) and the second unit may be referred to as Distributed Unit (DU) or Access Unit (AU). As another example, the first unit may be referred to as Digital Unit (DU) and the second unit may be referred to as Radio Unit (RU) or Remote Unit (RU). The Digital Unit (DU) may be a Base Band Unit (BBU) and the RU may be a Remote Radio Head (RRH) or a Remote Radio Unit (RRU). Of course, the names of the first unit (or first node) and the second unit (or second node) are not limited to such examples. Alternatively, the base station 200 may be a single unit (or single node). In this case, the base station 200 may be one of the plurality of units (for example, one of the first and second units) and may be connected to another unit of the plurality of units (for example, the other one of the first and second units).

### 4. First Example Embodiment

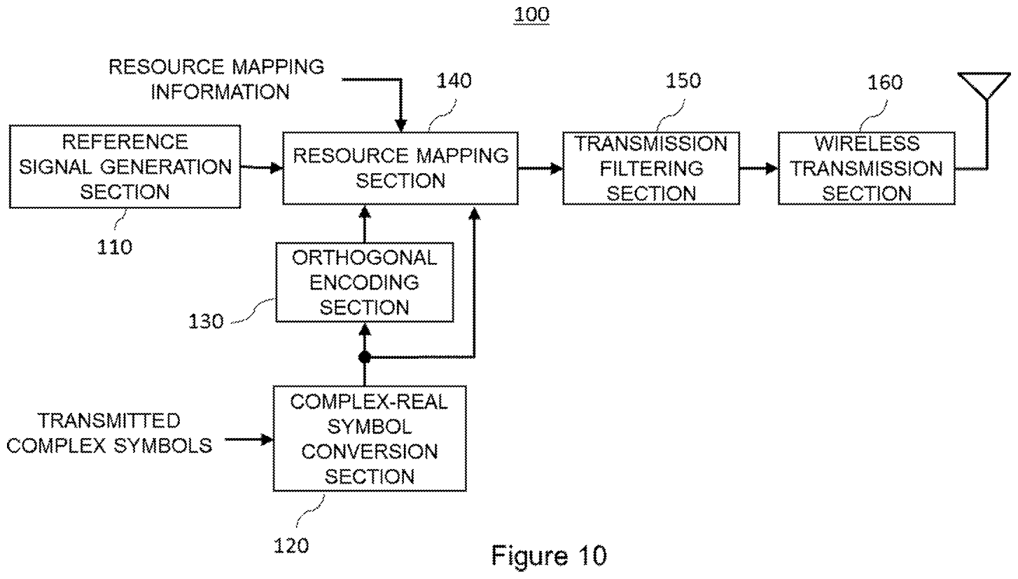

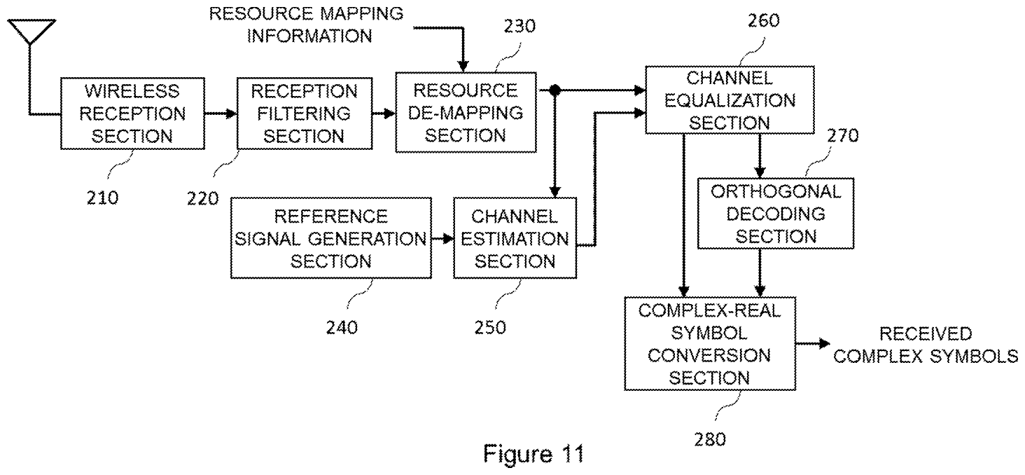

Next, with reference to FIGS. 10 and 11, the first example embodiment of the present invention will be described. In the first example embodiment, the terminal apparatus 100 transmits uplink data to the base station 200 and, thus, they include the following respective configurations.

### 4.1. Configuration of Terminal Apparatus

With reference to FIG. 10, an example of a configuration of the terminal apparatus 100 according to the first example embodiment will be described. FIG. 10 is a block diagram illustrating an example of a schematic configuration of the terminal apparatus 100 according to the first example embodiment. Referring to FIG. 10, the terminal apparatus 100, which is an instance of a first wireless communication apparatus according to the present invention, includes a reference signal generation section 110, a complex-real symbol conversion section 120, an orthogonal encoding section 130, a resource mapping section 140, a transmission filtering section 150 and a wireless transmission section 160 for performing wireless communication with the base station 200 in accordance with the FBMC/OQAM scheme.

### (1) Reference Signal Generation Section 110

The reference signal generation section 110 generates reference signals consisting only of real values in accordance with a predetermined procedure that is common to transmitting end (the terminal apparatus 100) and receiving end (the base station 200) and outputs them to the resource mapping section 140.

### (2) Complex-Real Symbol Conversion Section 120

A bit sequence as data for transmission to the base station 200 is converted through processing of modulation, pre-coding and the like into complex symbols, which is input to the complex-real symbol conversion section 120.

The complex-real symbol conversion section 120 converts the input complex symbols into real symbols on the basis of a predetermined rule. The complex-real symbol conversion section 120 outputs a symbol set of real symbols that are mapped to resource elements adjacent to a reference signal to the orthogonal encoding section 130 for orthogonal encoding and outputs real symbols which are not subject to orthogonal encoding to the resource mapping section 140.

### (3) Orthogonal Encoding Section 130

The orthogonal encoding section 130 generates, from real symbols that are subject to orthogonal encoding, orthogonally-encoded symbol set using a plurality of orthogonal codes that are common to transmitting end (the terminal apparatus 100) and receiving end (the base station 200) to output them to the resource mapping section 140.

### (4) Resource Mapping Section 140

Resource mapping information including information related to radio resources, the reference signals, real symbols and orthogonally-encoded real symbols are input to the resource mapping section 140. Herein, the radio resources are, specifically, resource blocks allocated to the terminal apparatus 100.

The resource mapping section 140 maps the reference signals, real symbols and orthogonally-encoded real symbols to respective resource elements arranged in frequency and time directions in the radio resources (resource blocks) allocated to the terminal apparatus 100 to output them to the transmission filtering section 150.

### (5) Transmission Filtering Section 150

The transmission filtering section 150 receives the real symbols mapped to respective resource elements by the resource mapping section 140 as inputs to perform FBMC/OQAM filtering based on the above-described (Expression 1) thereby generating base-band signals to output them to the wireless transmission section 160.

### (6) Wireless Transmission Section 160

The wireless transmission section 160 receives the base-band signals output from the transmission filtering section 150 as inputs to perform processing such as carrier frequency conversion, signal amplification and the like and transmits wireless signals from an antenna.

### (7) Implementation Example

The wireless transmission section 160 may be implemented with an antenna, a high frequency (Radio Frequency (RF)) circuit and the like and the antenna may be a directional antenna. The reference signal generation section 110, the complex-real symbol conversion section 120, the orthogonal encoding section 130, the resource mapping section 140 and the transmission filtering section 150 may be implemented with the same processor or with respective different processors.

The terminal apparatus 100 may include a memory that stores programs and one or more processors that are capable of executing the programs and the one or more processors may execute the operations of the reference signal generation section 110, the complex-real symbol conversion section 120, the orthogonal encoding section 130, the resource mapping section 140 and/or the transmission filtering section 150. The programs may be programs for causing the one or more processors to execute the operations of the reference signal generation section 110, the complex-real symbol conversion section 120, the orthogonal encoding section 130, the resource mapping section 140 and/or the transmission filtering section 150.

### 4.2. Configuration of Base Station

With reference to FIG. 11, an example of a configuration of the base station 200 according to the first example embodiment will be described. FIG. 11 is a block diagram illustrating an example of a schematic configuration of the base station 200 according to the first example embodiment. Referring to FIG. 11, the base station 200 includes a wireless reception section 210, a reception filtering section 220, a resource de-mapping section 230, a reference signal generation section 240, a channel estimation section 250, a channel equalization section 260, an orthogonal decoding section 270 and a real-complex symbol conversion section 280 for performing wireless communication with the base station 200 in accordance with the FBMC/OQAM scheme.

### (1) Wireless Reception Section 210

The wireless reception section 210 performs processing such as amplification, carrier frequency conversion and the like on signals received at an antenna thereby generating base-band signals and outputs them to the reception filtering section 220.

### (2) Reception Filtering Section 220

The reception filtering section 220 performs FBMC/OQAM filtering based on (Expression 5) to demultiplex symbols mapped to respective resource elements and outputs them to the resource de-mapping section 230.

### (3) Resource De-Mapping Section 230

The resource de-mapping section 230 extracts (de-maps) received reference signals and received symbols mapped to respective resource elements on the basis of the resource mapping information including information related to radio resources and outputs the received reference signals to the channel estimation section 250 and the received symbols to the channel equalization section 260. Herein, the radio resources are, specifically, resource blocks allocated to the terminal apparatus 100.

### (4) Reference Signal Generation Section 240

The reference signal generation section 240 generates known reference signals consisting only of real values in accordance with a predetermined procedure that is common to transmitting end (the terminal apparatus 100) and receiving end (the base station 200) and outputs them to the channel estimation section 250.

### (5) Channel Estimation Section 250

The channel estimation section 250 estimates fluctuation in phase and amplitude depending on channels on the basis of the known reference signals and the received reference signals and outputs channel estimates to the channel equalization section 260.

### (6) Channel Equalization Section 260

The channel equalization section 260 uses the channel estimates to perform channel equalization thereby compensating for the fluctuation in amplitude and phase for each received symbol and extracts only its real part. The channel equalization section 260 outputs, out of the resulting received real symbols, symbols that have been mapped to resource elements adjacent to a reference signal to the orthogonal decoding section 270 for orthogonal decoding and symbols that are not subject to orthogonal decoding to the real-complex symbol conversion section 280.

### (7) Orthogonal Decoding Section 270

The orthogonal decoding section 270 performs orthogonal decoding on the received real symbols that are subject to orthogonal decoding using orthogonal codes that are common to transmitting end (the terminal apparatus 100) and receiving end (the base station 200) to output them to the real-complex symbol conversion section 280.

### (8) Real-Complex Symbol Conversion Section 280

The received real symbols are input to the real-complex symbol conversion section 280 which converts them to complex symbols on the basis of the predetermined rule and outputs the resulting received complex symbols.

### (9) Implementation Example

The wireless reception section 210 may be implemented with an antenna, a high frequency (RF) circuit and the like. The reception filtering section 220, the resource de-mapping section 230, the reference signal generation section 240, the channel estimation section 250, the channel equalization section 260, the orthogonal decoding section 270 and/or the real-complex symbol conversion section 280 may be implemented with a base-band (BB) processor, another processor and/or the like.

The base station 200 may include a memory that stores programs and one or more processors that are capable of executing the programs and the one or more processors may execute the operations of the reception filtering section 220, the resource de-mapping section 230, the reference signal generation section 240, the channel estimation section 250, the channel equalization section 260, the orthogonal decoding section 270 and/or the real-complex symbol conversion section 280. The programs may be programs for causing the one or more processors to execute the operations of the reception filtering section 220, the resource de-mapping section 230, the reference signal generation section 240, the channel estimation section 250, the channel equalization section 260, the orthogonal decoding section 270 and/or the real-complex symbol conversion section 280.

### 4.3. Technical Features

Next, the technical features of the first example embodiment will be described.

(1) Technical Features Related to Terminal Apparatus 100

The terminal apparatus 100 (the orthogonal encoding section 130) generates, using a plurality of orthogonal codes, a second set of symbols from a first set of symbols to be transmitted to a second wireless communication apparatus. Then, the terminal apparatus (the resource mapping section 140) maps the second set of symbols to interfering resources which causes an interference affecting a target resource element.

(1-1) Target Resource Element

The target resource element is located at an edge of a radio resource in frequency direction or time direction, the radio resource being allocated to the terminal apparatus 100. Specifically, the radio resource is a resource block that is allocated to the terminal apparatus 100.

Further, the target resource element is a resource element to which a reference signal is mapped. Note that, of course, a reference signal may be mapped to another resource element.

For example, in the examples shown in FIGS. 5 and 6, the target resource element (m₀, n₀) is located at an edge of a resource block in time direction. In the examples shown in FIGS. 7 and 8, the target resource element (m₀, n₀) is located at an edge of a resource block in frequency direction.

If two or more resource blocks are allocated to the terminal apparatus 100 and the two or more resource blocks are consecutive in any one of time direction and frequency direction, the target resource element is located at an edge of the aggregation of the two or more resource blocks (in frequency direction or time direction).

(1-2) Orthogonal Codes

Each of the plurality of orthogonal codes used by the orthogonal encoding section 130 includes N elements. The N is an odd number. For example, in case of N being 3, each of the plurality of orthogonal codes includes a column vector from the orthogonal coding matrix C_{3×2} shown in (Expression 41). In case of N being 5, each of the plurality of orthogonal codes includes a column vector from the orthogonal coding matrix C_{5×4} shown in (Expression 57).

The first set of symbols includes (N−1) symbols. For example, the first set of symbols includes the real symbols x₀^{(m0,n0)}, x₁^{(m0,n0)}, . . . , x_{N-2}^{(m0,n0)} shown in (Expression 7) and (Expression 8).

The second set of symbols includes N symbols. For example, the second set of symbols includes the real symbols y₀^{(m0,n0)}, y₁^{(m0,n0)}, . . . , y_{N}^{(m0,n0)} shown in (Expression 7).

Each orthogonal code includes two elements whose absolute values are equal out of the N elements. For example, in the example shown in (Expression 41), each orthogonal code includes a pair of two elements having the same absolute values among the N (three) elements. Herein, looking at the column vector at the first column of the matrix shown in (Expression 41), it includes two elements having the absolute value of |1|. Looking at the column vector at the second column of the matrix shown in (Expression 41), it includes two elements having the absolute value of |d₀|.

A value generated using the two elements whose absolute values are equal from the second set of symbols is mapped to a pair of resource elements causing equal absolute values of interference affecting the target resource element. Though interfering resources will be described later, for example, the pair of resource elements with indices of (m₀+1, n₀) and (m₀−1, n₀) in (Expression 42), which is a pair of neighbors of the target resource element in frequency direction, causes equal absolute values of interference to the target resource element. In this case, values generated using the two elements whose absolute values are equal respectively from the symbols x₀^{(m0,n0)}, x₁^{(m0,n0)} are mapped to the two resource elements (m₀+1, n₀), (m₀−1, n₀) causing equal absolute values of interference to the target resource element.

(1-3) Interfering Resources

The interfering resources are N resource elements. The N is an odd number as mentioned above. Specifically, the interfering resources are N resource elements located around the target resource element. For example, as shown in FIGS. 5 to 8, the interfering resources may include resource elements neighboring the target resource element (m₀, n₀) in frequency direction and resource elements neighboring the target resource element (m₀, n₀) in time direction.

The interfering resources may further include resource elements as in the following examples. As an example, the interfering resources may further include two resource elements having positions one resource element shifted in time direction from the resource element neighboring the target resource element in the frequency direction as shown in FIGS. 7 and 8. As another example, the interfering resources may further include two resource elements having positions one resource element shifted in frequency direction from the resource element neighboring the target resource element in time direction as shown in FIGS. 5 and 6.

The interfering resources include one or more pairs of resource elements, and each of the one or more pairs of resource elements is a pair of resource elements causing equal absolute values of interference to the target resource element. Moreover, the one or more pairs include a pair of resource elements symmetrically arranged with respect to the target resource element in time-frequency plane. Furthermore, the interfering resources include a resource element causing an interference to the target resource element, magnitude of the interference being different than that of any other resource element included in the interfering resources.

For example, in the example shown in FIG. 5, there are pairs of resource elements causing equal absolute values of interference to the target resource element including the pair of resource elements (m₀−1, n₀), (m₀+1, n₀) neighboring the target resource element (m₀, n₀) in frequency direction and the pair of resource elements (m₀−1, n₀+1), (m₀+1, n₀+1) having positions one resource element shifted in frequency direction from the resource element (m₀, n₀+1) neighboring the target resource element (m₀, n₀) in time direction. The pair of resource elements symmetrically arranged with respect to the target resource element in time-frequency plane corresponds to the two resource elements (m₀−1, n₀), (m₀+1, n₀) neighboring the target resource element (m₀, n₀) in frequency direction. Further, the resource element causing, to the target resource element, an interference having a different magnitude than that of any other resource element included in the interfering resources corresponds to the resource element (m₀, n₀+1) neighboring the target resource element in time direction.

In the example shown in FIG. 7, there are pairs of resource elements causing equal absolute values of interference to the target resource element including the pair of resource elements (m₀, n₀−1), (m₀, n₀+1) neighboring the target resource element (m₀, n₀) in time direction and the pair of resource elements (m₀+1, n₀−1), (m₀+1, n₀+1) having positions one resource element shifted in time direction from the resource element (m₀+1, n₀) neighboring the target resource element (m₀, n₀) in frequency direction. The pair of resource elements symmetrically arranged with respect to the target resource element in time-frequency plane corresponds to the two resource elements (m₀, n₀−1), (m₀, n₀+1) neighboring the target resource element (m₀, n₀) in time direction. Further, the resource element causing, to the target resource element, an interference having a different magnitude than that of any other resource element included in the interfering resources corresponds to the resource element (m₀+1, n₀) neighboring the target resource element in frequency direction.

Note that the interfering resources are not limited to the examples shown in FIGS. 5 to 8 and they may be any resource elements causing an interference to the target resource element. For example, the interfering resources may include such as resource elements two or three elements distant from the target resource element in frequency or time direction and may be N resource elements located around the target resource element.

(1-4) Flow of Process

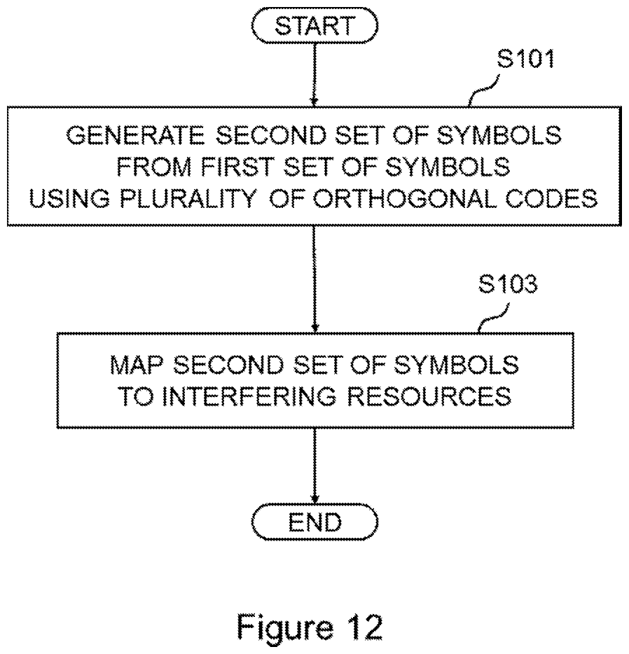

FIG. 12 is a flowchart for describing an example of a schematic flow of a process in the terminal apparatus 100 according to the first example embodiment.

The terminal apparatus 100 (the orthogonal encoding section 130) generates a second set of symbols including N real symbols from a first set of symbols including N−1 real symbols by performing orthogonal encoding based on (Expression 7) using a plurality of orthogonal codes (S101).

The terminal apparatus 100 (the resource mapping section 140) maps each symbol comprised in the second set of symbols generated in the step S101 to corresponding resource element included in the interfering resources which cause an interference affecting the target resource element (S103).

In this way, the second set of symbols generated using the orthogonal codes are mapped to interfering resources, thereby it will be possible to mitigate interference on the target resource element located at an edge, in frequency direction or time direction, of a radio resource allocated to the terminal apparatus 100.

(2) Technical Features Related to Base Station 200

The base station 200 (the resource de-mapping section 230) extracts, from a signal received from the terminal apparatus 100, a second set of symbols that are mapped to interfering resources causing an interference affecting a target resource element. Then, the base station 200 (the orthogonal decoding section 270) decodes the second set of symbols using the plurality of orthogonal codes to generate a first set of symbols.

Descriptions for the target resource elements, orthogonal codes and interfering resources may be similar to those described with regard to the terminal apparatus 100.

(2-1) Flow of Process

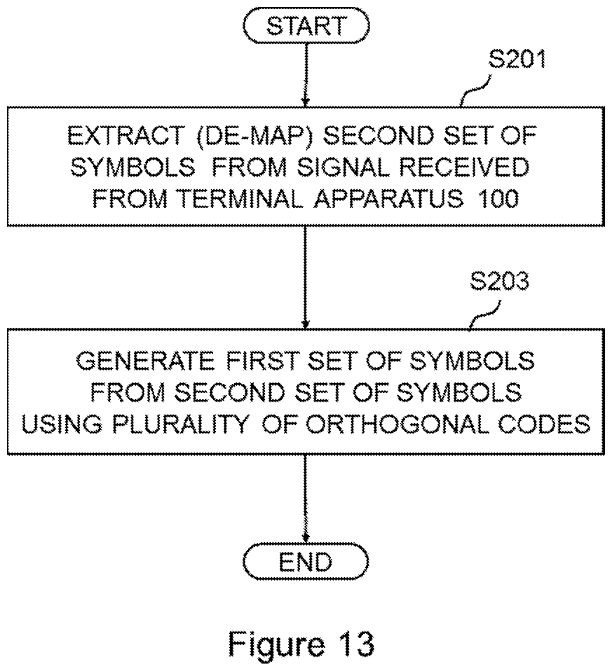

FIG. 13 is a flowchart for describing an example of a schematic flow of a process in the base station 200 according to the first example embodiment.

The base station 200 (the resource de-mapping section 230) extracts (de-maps), from a signal received from the terminal apparatus 100, a second set of symbols that are mapped to N resource elements included in the interfering resources causing an interference affecting the target resource element (S201).

The base station 200 (the orthogonal decoding section 270) decodes the second set of symbols including N real symbols by performing orthogonal decoding based on (Expression 10) using the plurality of orthogonal codes to generate the first set of symbols including N−1 real symbols (S203).

In this way, the second set of symbols mapped to interfering resources are decoded using the orthogonal codes to generate the first set of symbols, thereby it will be possible to mitigate interference on the target resource element located at an edge, in frequency direction or time direction, of a radio resource allocated to the terminal apparatus 100.

### 4.4. Example Alterations

(1) Complex Symbols

The example embodiment is not limited to the case where the first set of symbols and/or the second set of symbols are real symbols and complex symbols can also be used. That is, the symbols mapped to interfering resources may be complex symbols.

Specifically, orthogonal encoding using the orthogonal coding matrix C is possible even if the vector x^{(m0,n0)}_{N-1} before orthogonal encoding as shown in (Expression 8) is replaced with a complex symbol. This is because the conditions of (Expression 30) and (Expression 31) for generating the orthogonal coding matrix C do not depend on whether the value of the vector) x^{(m0,n0)}_{N-1} to be orthogonally encoded is real or not. This is easily applicable to the issues such as orthogonalization, interference cancellation and the like expressed in similar mathematical expressions.

(2) Downlink

The example embodiment is applicable not only to uplink but also to downlink. That is, the base station 200 may be taken as an instance of the first wireless communication apparatus according to the present invention and the terminal apparatus 100 may be taken as an instance of the second wireless communication apparatus according to the present invention.

Specifically, the base station 200 may map the second set of symbols generated from the first set of symbols using a plurality of orthogonal codes to interfering resources to transmit them to the terminal apparatus 100. Then, the terminal apparatus 100 may extract (de-map) the second set of symbols from a signal received from the base station 200 to generate the first set of symbols from the second set of symbols using the plurality of orthogonal codes. The base station 200 may include constituent elements which are similar to the constituent elements illustrated in FIG. 10 (the orthogonal encoding section 130, the resource mapping section 140 and the like) and the terminal apparatus 100 may include constituent elements which are similar to the constituent elements illustrated in FIG. 11 (the resource de-mapping section 230, the orthogonal decoding section 270 and the like).

(3) Target Resource Element

The target resource element that is subject to interference mitigation is not limited to the one to which a reference signal is mapped and any symbol other than the reference signal such as information symbol related to information to be transmitted may be mapped thereto, which can also mitigate interference affecting the target resource element.

### 5. Second Example Embodiment

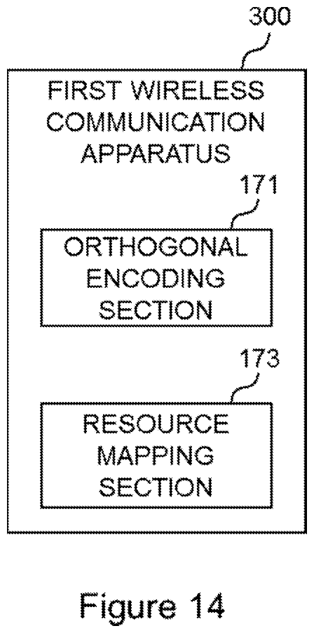

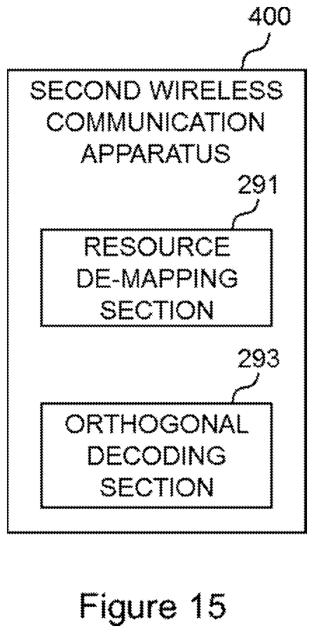

Next, a second example embodiment of the present invention will be described with reference to FIGS. 14 and 15. The foregoing first example embodiment is a concrete example embodiment whereas the second example embodiment is a more generalized example embodiment.

### <5.1. Configuration of First Wireless Communication Apparatus>

With reference to FIG. 14, an example of a configuration of the first wireless communication apparatus 300 according to the second example embodiment will be described. FIG. 14 is a block diagram illustrating an example of a schematic configuration of the first wireless communication apparatus 300 according to the second example embodiment. Referring to FIG. 14, the first wireless communication apparatus 300, which is an apparatus to transmit a signal to a second wireless communication apparatus 400 mentioned below, includes an orthogonal encoding section 171 and a resource mapping section 173.

Specific operations of the orthogonal encoding section 171 and the resource mapping section 173 will be described later.

The orthogonal encoding section 171 and the resource mapping section 173 may be implemented with a base-band (BB) processor, another processor and/or the like. The orthogonal encoding section 171 and the resource mapping section 173 may be implemented with the same processor or with respective different processors.

The first wireless communication apparatus 300 may include a memory that stores programs and one or more processors that are capable of executing the programs and the one or more processors may execute the operations of the orthogonal encoding section 171 and the resource mapping section 173. The programs may be programs for causing the one or more processors to execute the operations of the orthogonal encoding section 171 and the resource mapping section 173.

### <5.2. Configuration of Second Wireless Communication Apparatus>

With reference to FIG. 15, an example of a configuration of the second wireless communication apparatus 400 according to the second example embodiment will be described. FIG. 15 is a block diagram illustrating an example of a schematic configuration of the second wireless communication apparatus 400 according to the second example embodiment. Referring to FIG. 15, the second wireless communication apparatus 400, which is an apparatus to wirelessly communicate with the first wireless communication apparatus 300 as mentioned above, includes a resource de-mapping section 291 and an orthogonal decoding section 293.

Specific operations of the resource de-mapping section 291 and the orthogonal decoding section 293 will be described later.

The resource de-mapping section 291 and the orthogonal decoding section 293 may be implemented with a base-band (BB) processor, another processor and/or the like. The resource de-mapping section 291 and the orthogonal decoding section 293 may be implemented with the same processor or with respective different processors.

The second wireless communication apparatus 400 may include a memory that stores programs and one or more processors that are capable of executing the programs and the one or more processors may execute the operations of the resource de-mapping section 291 and the orthogonal decoding section 293. The programs may be programs for causing the one or more processors to execute the operations of the resource de-mapping section 291 and the orthogonal decoding section 293.

### <5.3. Technical Features>

Next, technical features of the second example embodiment will be described.

(1) Technical Features Related to First Wireless Communication Apparatus 300

The first wireless communication apparatus 300 (the orthogonal encoding section 171) is configured to generate, using a plurality of orthogonal codes, a second set of symbols from a first set of symbols to be transmitted to the second wireless communication apparatus. The first wireless communication apparatus 300 (the resource mapping section 173) is configured to map the second set of symbols to interfering resources which cause an interference affecting a target resource element.

Herein, the target resource element is located at an edge of a radio resource in frequency direction or time direction, the radio resource being allocated to the first wireless communication apparatus 300 or the second wireless communication apparatus 400. Descriptions for orthogonal codes and interfering resources are similar to the descriptions related to the first example embodiment. That is, each of the plurality of orthogonal codes includes N elements. The interfering resources are N resource elements. The N is an odd number.

In this way, the second set of symbols generated from the first set of symbols using the orthogonal codes are mapped to interfering resources, thereby it will be possible to mitigate interference on the target resource element located at an edge in frequency direction or time direction.

(2) Technical Features Related to Second Wireless Communication Apparatus 400

The second wireless communication apparatus 400 (the resource de-mapping section 291) is configured to extract, from a signal received from the first wireless communication apparatus 300, the second set of symbols that are mapped to interfering resources causing an interference affecting a target resource element. The second wireless communication apparatus 400 (the orthogonal decoding section 293) is configured to decode the second set of symbols using the plurality of orthogonal codes to generate the first set of symbols.

Herein, the target resource element is located at an edge of a radio resource in frequency direction or time direction, the radio resource being allocated to the first wireless communication apparatus 300 or the second wireless communication apparatus 400. Descriptions for orthogonal codes and interfering resources are similar to the descriptions related to the first example embodiment. That is, each of the plurality of orthogonal codes includes N elements. The interfering resources are N resource elements. The N is an odd number.

In this way, the first set of symbols is generated from the second set of symbols mapped to the interfering resources using the orthogonal codes, thereby it will be possible to mitigate interference on the target resource element located at an edge, in frequency direction or time direction, of the first wireless communication apparatus 300 or the second wireless communication apparatus 400.

Though example embodiments of the present invention have been described herein, the present invention is not limited to these example embodiments. It will be understood by those of ordinary skill in the art that these example embodiments are illustrative only and that various alterations can be done without departing from the scope and spirit of the present invention.

For example, it is applicable not only to the FBMC/OQAM scheme but also to another communication scheme which maps symbols to non-orthogonal resource elements arranged in frequency and time directions. A further step may be added to a process as a step in the process described in the present specification.

Moreover, an apparatus (for example, one or more apparatuses (or units) out of a plurality of apparatuses (or units) comprised in the first wireless communication apparatus) or a module (for example, a module for one of the plurality of apparatuses (or units)) including constituent elements of the first wireless communication apparatus described in the present specification (for example, the orthogonal encoding section and/or the resource mapping section) may be provided. A module including constituent elements of the second wireless communication apparatus described in the present specification (for example, the resource de-mapping section and/or the orthogonal decoding section) may be provided. In addition, methods including processes of such constituent elements may be provided, and programs for causing processors to execute processes of such constituent elements may be provided. Furthermore, computer-readable non-transitory recording media (non-transitory computer readable media) having recorded thereon such programs may be provided. It is apparent that such apparatuses, modules, methods, programs and computer-readable non-transitory recording media are also included in the present invention.

Some or all of the above-described example embodiments can be described as in the following Supplementary Notes, but are not limited to the following.

### (Supplementary Note 1)

A first wireless communication apparatus comprising:

an orthogonal encoding section configured to generate, using a plurality of orthogonal codes, a second set of symbols from a first set of symbols to be transmitted to a second wireless communication apparatus; and

a resource mapping section configured to map the second set of symbols to interfering resources which cause an interference affecting a target resource element,

wherein the target resource element is located at an edge of a radio resource in frequency direction or time direction, the radio resource being allocated to the first wireless communication apparatus or the second wireless communication apparatus,

each of the plurality of orthogonal codes includes N elements,

the interfering resources are N resource elements, and

the N is an odd number.

### (Supplementary Note 2)

The first wireless communication apparatus according to Supplementary Note 1, wherein

the first wireless communication apparatus is a base station, and

the second wireless communication apparatus is a terminal apparatus.

### (Supplementary Note 3)

The first wireless communication apparatus according to Supplementary Note 1, wherein

the first wireless communication apparatus is a terminal apparatus, and

the second wireless communication apparatus is a base station.

### (Supplementary Note 4)

The first wireless communication apparatus according to Supplementary Note 2 or 3, wherein the radio resource is a radio resource allocated to the terminal apparatus.

### (Supplementary Note 5)

The first wireless communication apparatus according to Supplementary Note 4, wherein the radio resource allocated to the terminal apparatus includes a resource block allocated to the terminal apparatus.

### (Supplementary Note 6)

The first wireless communication apparatus according to Supplementary Note 5, wherein the radio resource includes two or more resource blocks allocated to the terminal apparatus, the two or more resource blocks being consecutive at least in any one of frequency direction and time direction.

### (Supplementary Note 7)

The first wireless communication apparatus according to any one of Supplementary Notes 1 to 6, wherein the first set of symbols includes (N−1) symbols.

### (Supplementary Note 8)

The first wireless communication apparatus according to any one of Supplementary Notes 1 to 7, wherein the second set of symbols includes N symbols.

### (Supplementary Note 9)

The first wireless communication apparatus according to any one of Supplementary Notes 1 to 8, wherein the interfering resources are N resource elements located around the target resource element.

### (Supplementary Note 10)

The first wireless communication apparatus according to Supplementary Note 9, wherein the interfering resources include a resource element neighboring the target resource element in frequency direction and a resource element neighboring the target resource element in time direction.

### (Supplementary Note 11)

The first wireless communication apparatus according to Supplementary Note 10, wherein the interfering resources further include two resource elements having positions one resource element shifted in time direction from the resource element neighboring the target resource element in the frequency direction.

### (Supplementary Note 12)

The first wireless communication apparatus according to Supplementary Note 10, wherein the interfering resources further include two resource elements having positions one resource element shifted in frequency direction from the resource element neighboring the target resource element in the time direction.

### (Supplementary Note 13)

The first wireless communication apparatus according to any one of Supplementary Notes 1 to 12, wherein

the interfering resources include one or more pairs of resource elements, and

each of the one or more pairs of resource elements is a pair of resource elements causing equal absolute values of interference to the target resource element.

### (Supplementary Note 14)

The first wireless communication apparatus according to Supplementary Note 13, wherein the one or more pair includes a pair of resource elements symmetrically arranged with respect to the target resource element in time-frequency plane.

### (Supplementary Note 15)

The first wireless communication apparatus according to Supplementary Note 13 or 14, wherein the interfering resources include a resource element causing an interference to the target resource element, magnitude of the interference being different than that of any other resource element included in the interfering resources.

### (Supplementary Note 16)

The first wireless communication apparatus according to any one of Supplementary Notes 13 to 15, wherein

the orthogonal code includes two elements whose absolute values are equal out of the N elements, and

a value generated using the two elements whose absolute values are equal is mapped to one of the one or more pairs of resource elements.

### (Supplementary Note 17)

The first wireless communication apparatus according to any one of Supplementary Notes 1 to 16, wherein the target resource element is a resource element to which a reference signal is mapped.

### (Supplementary Note 18)

A second wireless communication apparatus comprising:

a resource de-mapping section configured to extract, from a signal received from a first wireless communication apparatus, a second set of symbols that are mapped to interfering resources causing an interference affecting a target resource element; and

an orthogonal decoding section configured to decode the second set of symbols using a plurality of orthogonal codes to generate a first set of symbols,

wherein the target resource element is located at an edge of a radio resource in frequency direction or time direction, the radio resource being allocated to the second wireless communication apparatus or the first wireless communication apparatus,

each of the plurality of orthogonal codes includes N elements,

the interfering resources are N resource elements, and

the N is an odd number.

### (Supplementary Note 19)

A method comprising:

generating, using a plurality of orthogonal codes, a second set of symbols from a first set of symbols to be transmitted from a first wireless communication apparatus to a second wireless communication apparatus; and

mapping the second set of symbols to interfering resources which cause an interference affecting a target resource element,

wherein the target resource element is located at an edge of a radio resource in frequency direction or time direction, the radio resource being allocated to the first wireless communication apparatus or the second wireless communication apparatus,

each of the plurality of orthogonal codes includes N elements,

the interfering resources are N resource elements, and

the N is an odd number.

### (Supplementary Note 20)

A method comprising:

extracting, from a signal that a second wireless communication apparatus received from a first wireless communication apparatus, a second set of symbols that are mapped to interfering resources causing an interference affecting a target resource element; and

decoding the second set of symbols using a plurality of orthogonal codes to generate a first set of symbols,

wherein the target resource element is located at an edge of a radio resource in frequency direction or time direction, the radio resource being allocated to the second wireless communication apparatus or the first wireless communication apparatus,

each of the plurality of orthogonal codes includes N elements,

the interfering resources are N resource elements, and

the N is an odd number.

### (Supplementary Note 21)

A program for causing a processor to execute:

generating, using a plurality of orthogonal codes, a second set of symbols from a first set of symbols to be transmitted from a first wireless communication apparatus to a second wireless communication apparatus; and

mapping the second set of symbols to interfering resources which cause an interference affecting a target resource element,

wherein the target resource element is located at an edge of a radio resource in frequency direction or time direction, the radio resource being allocated to the first wireless communication apparatus or the second wireless communication apparatus,

each of the plurality of orthogonal codes includes N elements,

the interfering resources are N resource elements, and

the N is an odd number.

### (Supplementary Note 22)

A program for causing a processor to execute:

extracting, from a signal that a second wireless communication apparatus received from a first wireless communication apparatus, a second set of symbols that are mapped to interfering resources causing an interference affecting a target resource element; and

decoding the second set of symbols using a plurality of orthogonal codes to generate a first set of symbols,

wherein the target resource element is located at an edge of a radio resource in frequency direction or time direction, the radio resource being allocated to the second wireless communication apparatus or the first wireless communication apparatus,

each of the plurality of orthogonal codes includes N elements,

the interfering resources are N resource elements, and

the N is an odd number.

### (Supplementary Note 23)

A non-transitory computer-readable recording medium having recorded thereon a program for causing a processor to execute:

generating, using a plurality of orthogonal codes, a second set of symbols from a first set of symbols to be transmitted from a first wireless communication apparatus to a second wireless communication apparatus; and

mapping the second set of symbols to interfering resources which cause an interference affecting a target resource element,

wherein the target resource element is located at an edge of a radio resource in frequency direction or time direction, the radio resource being allocated to the first wireless communication apparatus or the second wireless communication apparatus,

each of the plurality of orthogonal codes includes N elements,

the interfering resources are N resource elements, and

the N is an odd number.

### (Supplementary Note 24)

A non-transitory computer-readable recording medium having recorded thereon a program for causing a processor to execute:

extracting, from a signal that a second wireless communication apparatus received from a first wireless communication apparatus, a second set of symbols that are mapped to interfering resources causing an interference affecting a target resource element; and

decoding the second set of symbols using a plurality of orthogonal codes to generate a first set of symbols,

wherein the target resource element is located at an edge of a radio resource in frequency direction or time direction, the radio resource being allocated to the second wireless communication apparatus or the first wireless communication apparatus,

each of the plurality of orthogonal codes includes N elements,

the interfering resources are N resource elements, and

the N is an odd number.

This application claims priority based on Japanese Patent Application No. 2016-214075 filed on Nov. 1, 2016, the entire disclosure of which is incorporated herein.

### INDUSTRIAL APPLICABILITY

In a communication scheme which maps symbols to resource elements arranged in frequency direction and time direction, it will be possible to mitigate interference that arises in a resource element located at an edge of a radio resource, allocated to a wireless communication apparatus, in frequency direction or time direction.

### REFERENCE SIGNS LIST

1 System
100 Terminal Apparatus
130, 171 Orthogonal Encoding Section
140, 173 Resource Mapping Section
200 Base Station
230, 291 Resource De-mapping Section
270, 293 Orthogonal Decoding Section
300 First Wireless Communication Section
400 Second Wireless Communication Section

1-24. (canceled)

25. A first wireless communication apparatus comprising:
a controller configured to:
generate, using a plurality of orthogonal codes, a second set of symbols from a first set of symbols to be transmitted to a second wireless communication apparatus; and
map the second set of symbols to interfering resources which cause an interference affecting a target resource element,
wherein the target resource element is located at an edge of a radio resource in frequency direction or time direction, the radio resource being allocated to the first wireless communication apparatus or the second wireless communication apparatus,
each of the plurality of orthogonal codes includes N elements,
the interfering resources are N resource elements, and
the N is an odd number.

26. The first wireless communication apparatus according to claim 25, wherein
the first wireless communication apparatus is a base station, and
the second wireless communication apparatus is a terminal apparatus.

27. The first wireless communication apparatus according to claim 25, wherein
the first wireless communication apparatus is a terminal apparatus, and
the second wireless communication apparatus is a base station.

28. The first wireless communication apparatus according to claim 26, wherein the radio resource is a radio resource allocated to the terminal apparatus.

29. The first wireless communication apparatus according to claim 28, wherein the radio resource allocated to the terminal apparatus includes a resource block allocated to the terminal apparatus.

30. The first wireless communication apparatus according to claim 29, wherein the radio resource includes two or more resource blocks allocated to the terminal apparatus, the two or more resource blocks being consecutive at least in any one of frequency direction and time direction.

31. The first wireless communication apparatus according to claim 25, wherein the first set of symbols includes (N−1) symbols.

32. The first wireless communication apparatus according to claim 25, wherein the second set of symbols includes N symbols.

33. The first wireless communication apparatus according to claim 25, wherein the interfering resources are N resource elements located around the target resource element.

34. The first wireless communication apparatus according to claim 33, wherein the interfering resources include a resource element neighboring the target resource element in frequency direction and a resource element neighboring the target resource element in time direction.

35. The first wireless communication apparatus according to claim 34, wherein the interfering resources further include two resource elements having positions one resource element shifted in time direction from the resource element neighboring the target resource element in the frequency direction.

36. The first wireless communication apparatus according to claim 34, wherein the interfering resources further include two resource elements having positions one resource element shifted in frequency direction from the resource element neighboring the target resource element in the time direction.

37. The first wireless communication apparatus according to claim 25, wherein
the interfering resources include one or more pairs of resource elements, and
each of the one or more pairs of resource elements is a pair of resource elements causing equal absolute values of interference to the target resource element.

38. The first wireless communication apparatus according to claim 37, wherein the one or more pair includes a pair of resource elements symmetrically arranged with respect to the target resource element in time-frequency plane.

39. The first wireless communication apparatus according to claim 25, wherein the interfering resources include a resource element causing an interference to the target resource element, magnitude of the interference being different than that of any other resource element included in the interfering resources.

40. The first wireless communication apparatus according to claim 25, wherein
the orthogonal code includes two elements whose absolute values are equal out of the N elements, and
a value generated using the two elements whose absolute values are equal is mapped to one of the one or more pairs of resource elements.

41. The first wireless communication apparatus according to claim 25, wherein the target resource element is a resource element to which a reference signal is mapped.

42. A second wireless communication apparatus comprising:
a controller configured to:
extract, from a signal received from a first wireless communication apparatus, a second set of symbols that are mapped to interfering resources causing an interference affecting a target resource element; and
decode the second set of symbols using a plurality of orthogonal codes to generate a first set of symbols,
wherein the target resource element is located at an edge of a radio resource in frequency direction or time direction, the radio resource being allocated to the second wireless communication apparatus or the first wireless communication apparatus,
each of the plurality of orthogonal codes includes N elements,
the interfering resources are N resource elements, and
the N is an odd number.

43. A method comprising:
generating, using a plurality of orthogonal codes, a second set of symbols from a first set of symbols to be transmitted from a first wireless communication apparatus to a second wireless communication apparatus; and
mapping the second set of symbols to interfering resources which cause an interference affecting a target resource element,
wherein the target resource element is located at an edge of a radio resource in frequency direction or time direction, the radio resource being allocated to the first wireless communication apparatus or the second wireless communication apparatus,
each of the plurality of orthogonal codes includes N elements,
the interfering resources are N resource elements, and
the N is an odd number.
